(19) United States
(12) Patent Application Publication
(10) Pub. No.: US 2026/0050982 A1
(43) Pub. Date: Feb. 19, 2026

(54) System and Method for Liquidity Provisioning Through an Automated Liquidity Pool (ALP)

(71) Applicant: Pontoro Inc., Mountain View, CA (US)

(72) Inventors: Emiliano Pelliccioni, Cordoba (AR); Shikhar Verma, San Francisco, CA (US); Robert Dewing, Mountain Lakes, NJ (US); Jacqueline Dentner, Downingtown, PA (US); Josh A. Pandolfi, Danbury, CT (US); Antonio Vitti, Fremont, CA (US)

(21) Appl. No.: 19/302,491

(22) Filed: Aug. 18, 2025

Related U.S. Application Data
(60) Provisional application No. 63/683,861, filed on Aug. 16, 2024.

(51) Int. Cl. G06Q 40/06; G06Q 30/0207

(52) U.S. Cl. CPC G06Q 40/06; G06Q 30/0216

(57) ABSTRACT

Embodiments are directed towards a computer-implemented method. The method may include receiving an asset owned by a user, in response to accepting the asset, determining a projected liquidity ratio for one or more liquidity buckets, and splitting a discount into a first and second discount. The method may also include applying the first discount based on a credit risk or valuation risk profile, calculating the second discount based on the projected liquidity ratio and using a discount function, and allocating the asset to one or more liquidity buckets based on what type of liquidity transaction is used, and a set of bucket attributes associated with each liquidity bucket. The method may further include transferring a capital amount equal to a net asset value of the asset minus the first and second discounts minus fees and expenses, and distributing a return from a pool of managed assets to the user.

### CROSS-REFERENCE TO RELATED APPLICATIONS

This application claims the benefit of U.S. provisional application 63/683,861, which was filed on Aug. 16, 2024 the contents of which is hereby incorporated by reference in its entirety.

### BACKGROUND

The private fund industry may be currently facing significant liquidity and distribution challenges. Limited Partners (LPs), including institutional and retail investors, may typically lock up their capital for ten or more years with very few and inefficient liquidity options. Traditional methods like selling to a secondary fund may take 3-6 months, include multiple points of failure, and often result in unattractive/unfavorable sale prices. These liquidity challenges may have led to a massive supply/demand imbalance, with too many sellers and not enough buyers.

The inherently illiquid nature of private assets may impact secondary market trading and increase the liquidity premium demanded by investors. Since 2021, very little capital has been returned from private funds, leaving investors unable to access their money and potentially missing new opportunities.

Current secondary trading methods may be time-consuming and require extensive user input, which may in turn reduce the efficiency in making transactions in furtherance of an LP's interests.

Real-world asset tokenization may have become a transformative trend in the fintech industry, enabling the digitization of financial assets on the blockchain. By integrating smart contracts, tokenization may ensure seamless transactions and may transform a fund unit, which is simply a passive bookkeeping element, into an active financial instrument that may be used to execute operations on its own as it travels a network of participants, thereby enhancing transparency, accessibility, and liquidity for investors. As this technology matures, it may promise to revolutionize how assets are managed, traded, and recorded, allowing for more efficient and inclusive financial ecosystems.

Although tokenization may revolutionize the financial world, several challenges remain to be solved. Transforming inherently illiquid assets into a token format may not mean that liquidity emerges without additional support from external mechanisms. Several attempts may exist in the market today, but solving the liquidity issue remains extremely difficult. Applications that implement bulletin boards where token holders may post offers to sell or buy tokens may not gain traction because there may be a lack of valuation information or a lack of connected market and complex asset structures, which may lead to the existence of more sellers than buyers on most platforms. Similarly, other platforms implementing exchange-like interfaces may face the same issue, struggling to attract sufficient buy-side interest to balance out the market. These attempts may be limited by 1:1 matching, 1:1 price discovery, no pricing signal propagation, and are dependent on external market makers.

### SUMMARY

In one or more embodiments of the present disclosure, a computer-implemented method, executed on at least one server having a processor and a memory coupled over a network, for providing liquidity for financial assets is presented. The method may include receiving, using the processor or via a blockchain an asset owned by a user, in response to accepting the asset, determining, using the processor executing a core algorithm, a projected liquidity ratio for one or more liquidity buckets stored in a database accessible to the at least one server, and splitting a discount into a first discount and a second discount, wherein the first discount may be based on credit risk and valuation risk, wherein the second discount may be based on liquidity risk. The method may also include applying, using the processor, the first discount based on a credit risk profile retrieved from a networked data store or the blockchain, calculating, using the processor, a second discount based on the projected liquidity ratio and using a discount function stored in the memory, and allocating, using the processor, the asset to one or more liquidity buckets based on what type of liquidity transaction may be used, and on a set of bucket attributes associated with each liquidity bucket, wherein the liquidity buckets may be maintained in the database stored on the at least one server. The method may further include transferring, using a network connected payment rail to the user providing liquid capital, a capital amount equal to a net asset value of the asset minus the first and second discounts and minus fees and expenses (payout=asset value−1 st discount-2nd discount−fees−expenses), and distributing, using an income-distribution model executed on the at least one server, a return from a pool of managed assets to the user, wherein the pool of managed assets may be stored in a digital asset registry accessible by the system.

One or more of the following features may be included. The return from the pool of managed assets may be split into a plurality of share classes and distributed to one or more users associated with each share class of the plurality of share classes. The second discount may be determined using a dynamic discount curve selected from at least one of an exponential decay model or a multi-parameter bounded function. The method may further include reinvesting a portion of the return into one or more new liquidity buckets, and updating at least one of the networked data store or the blockchain to reflect the reinvestment. The core algorithm may be a modular algorithm and may further include an allocation sub-algorithm configured to determine an optimal allocation of assets into the one or more liquidity buckets, an income-distribution sub-algorithm configured to distribute the return generated by the pool of managed assets, and a pricing sub-algorithm configured to dynamically adjust at least one of a purchase discount or premium or a sale price for each asset based on real-time liquidity conditions within the pool of managed assets. The type of liquidity transaction used may be at least one of: a direct purchase/sale, a repurchase agreement, or a hypothecation. The core algorithm may be configured to automatically adjust the second discount amount to create incentives or disincentives with the objective of countering liquidity changes in the pool of managed assets. The set of bucket attributes may include at least one of: a lock-up period, a deposit size, a maturity date, or a current liquidity ratio. The return distribution among multiple share classes may be executed using an algorithm configured to consider a relative size of the share classes and an additional return from the assets returning above a reference rate.

In another embodiment of the present disclosure, a computing system is provided. The computing system may include a memory, and a processor configured to receive, using the processor or via a blockchain an asset owned by a user, to determine, via a core algorithm, a projected liquidity ratio for one or more liquidity buckets stored in a database accessible to the at least one server, to split a discount into a first discount and a second discount, wherein the first discount may be based on credit risk and valuation risk, wherein the second discount may be based on liquidity risk, to apply, using the processor, the first discount based on a credit risk profile retrieved from a networked data store or the blockchain, to calculate a second discount based on the projected liquidity ratio and using a discount function stored in the memory, to allocate the asset to one or more liquidity buckets based on what type of liquidity transaction may be used, and a set of bucket attributes associated with each liquidity bucket, wherein the liquidity buckets may be maintained in a structured database stored on the at least one server, to transfer, using a network connected payment rail, to the user providing liquid capital, a capital amount equal to a net asset value of the asset minus the first and second discounts and minus fees and expenses (payout=asset value−1st discount−2nd discount−fees−expenses), and to distribute, using an income-distribution model executed on the at least one server, a return from a pool of managed assets to the user, wherein the pool of managed assets may be stored in a digital asset registry accessible by the computing system.

One or more of the following features may be included. The return from the pool of managed assets may be split into a plurality of share classes and distributed to one or more users associated with each share class of the plurality of share classes. The second discount may be determined using a dynamic discount curve selected from at least one of an exponential decay model or a multi-parameter bounded function. The second discount may be determined using a dynamic discount curve selected from at least one of an exponential decay model or a multi-parameter bounded function. The processor may be further configured to reinvest a portion of the return into one or more new liquidity buckets, and to update at least one of the networked data store or the blockchain to reflect the reinvestment. The return distribution among multiple share classes may be executed using an algorithm configured to consider a relative size of the share classes and an additional return from the assets returning above a reference rate.

In yet another embodiment of the present disclosure, a non-transitory computer-readable medium may be provided. The non-transitory computer-readable medium may have stored thereon instructions, which, when executed by a processor, may result in one or more operations. The resulting operations may include receiving, using the processor or via a blockchain an asset owned by a user, in response to accepting the asset, determining, using a core algorithm, a projected liquidity ratio for one or more liquidity buckets stored in a database accessible to at least one server, and splitting a discount into a first discount and a second discount, where the first discount may be based on credit risk and valuation risk, where the second discount may be based on liquidity risk. The operations may also include applying, using the processor, the first discount based on a credit risk profile retrieved from a networked data store or the blockchain, calculating, using the processor, a second discount based on the projected liquidity ratio and using a discount function stored in the memory, and allocating, using the processor, the asset to one or more liquidity buckets based on what type of liquidity transaction may be used, and a set of bucket attributes associated with each liquidity bucket, where the liquidity buckets may be maintained in the database stored on the at least one server. The operations may further include transferring, using a network connected payment rail to the user providing liquid capital, a capital amount equal to a net asset value of the asset minus the first and second discounts and minus fees and expenses (payout=asset value−1st discount−2nd discount−fees−expenses), and distributing, using an income-distribution model executed on the at least one server, a return from a pool of managed assets to the user, wherein the pool of managed assets may be stored in a digital asset registry accessible by the system.

One or more of the following features may be included. The return from the pool of managed assets may be split into a plurality of share classes and distributed to one or more users associated with each share class of the plurality of share classes. The second discount may be determined using a dynamic discount curve selected from at least one of an exponential decay model or a multi-parameter bounded function. The core algorithm may be a modular algorithm and may further include an allocation sub-algorithm configured to determine an optimal allocation of assets into the one or more liquidity buckets, an income-distribution sub-algorithm configured to distribute the return generated by the pool of managed assets, and a pricing sub-algorithm configured to dynamically adjust at least one of a purchase discount or premium or a sale price for each asset based on real-time liquidity conditions within the pool of managed assets. The operations may further include reinvesting a portion of the return into one or more new liquidity buckets, and updating at least one of the networked data store or the blockchain to reflect the reinvestment.

In additional embodiment, a method executed on at least one server having a processor and a memory coupled over a network is provided. The method may include receiving, using the processor an asset and determining a projected liquidity ratio for one or more liquidity buckets stored in a database accessible by the at least one server. The method may further include splitting a discount into a first discount and a second discount, wherein the first discount is based on credit risk and valuation risk, wherein the second discount is based on liquidity risk. The method may also include applying, using the processor, the first discount based on a credit risk profile retrieved from a networked data store or a blockchain. The method may further include calculating, using the processor, a second discount based on the projected liquidity ratio and using a discount function. The method may also include allocating, using the processor, the asset to one or more liquidity buckets based on what type of liquidity transaction is used, and a set of bucket attributes associated with each liquidity bucket. The method may additionally include transferring a capital amount equal to a net asset value of the asset minus the first and second discounts and minus fees and expenses and distributing, using an income-distribution model, a return from a pool of managed assets, wherein the pool of managed assets are stored in a digital asset registry. Numerous other operations are also within the scope of the present disclosure.

### BRIEF DESCRIPTION OF THE DRAWINGS

The accompanying drawings, which are included to provide a further understanding of embodiments of the present disclosure and are incorporated in and constitute a part of this specification, illustrate embodiments of the present disclosure and together with the description serve to explain the principles of embodiments of the present disclosure.

FIG. 1 diagrammatically depicts a liquidity transaction in accordance with embodiments of the present disclosure;

FIG. 2 diagrammatically depicts a liquidity pool, in accordance with embodiments of the present disclosure;

FIG. 3 diagrammatically depicts a liquidity pool, in accordance with embodiments of the present disclosure;

FIG. 4 diagrammatically depicts the effects of an automated liquidity pool (ALP) algorithm on a liquidity ratio, in accordance with embodiments of the present disclosure;

FIG. 5 is an example diagrammatic view of an ALP transaction process coupled to a distributed computing network, in accordance with embodiments of the present disclosure;

FIG. 6 diagrammatically depicts an ALP smart contract coupled to a distributed computing network;

FIG. 7 shows an exemplary flowchart of a liquidity transaction for repurchase and hypothecation deals, in accordance with embodiments of the present disclosure;

FIG. 8 shows a flowchart of an ALP process, in accordance with embodiments of the present disclosure;

FIG. 9 diagrammatically depicts a line chart of a liquidity distribution over time, in accordance with embodiments of the present disclosure;

FIG. 10 diagrammatically depicts a graph of a yield allocation among different share classes, in accordance with embodiments of the present disclosure;

FIG. 11 diagrammatically depicts a graph of a yield allocation among different share classes, in accordance with embodiments of the present disclosure;

FIG. 12 diagrammatically depicts a graph of an exponential decay discount curve function, in accordance with embodiments of the present disclosure; and

FIG. 13 diagrammatically depicts a graph of a “4-Greeks” discount curve function, in accordance with embodiments of the present disclosure.

### DETAILED DESCRIPTION

The private fund industry may currently be facing significant liquidity challenges.

This problem may be exacerbated by low distributions to paid-in capital (DPIs), where DPI may be a key performance metric used in private equity, venture capital, and other closed-end investment funds to measure how much capital has been returned to investors relative to what they initially invested.

The disclosure below may relate to a system and methodology that funds may utilize to provide liquidity to investors, allowing LPs an easy way to exit their positions without the added challenge of finding a counterparty willing to take the opposite side of their trade, or conversely allowing new investors an easy way to invest in private funds. Furthermore, the invention may provide a credible avenue for liquidity suppliers to get stable yields backed by institutional-grade real-world assets. Liquidity suppliers may be anyone with capital in the form of fiat currency, cryptocurrency or securities that may be used for investing in the ALP, discussed in greater detail below.

The disclosure below may primarily discuss liquidity transactions in the context of blockchain and tokenization technology. While “liquidity transactions” may work better with blockchain technology and tokenized assets because the tokenized versions may have better data sharing and programmability, liquidity transactions may also incorporate non-tokenized assets through non-blockchain financial infrastructure. This point is discussed in greater detail in the paragraphs below.

Reference will now be made in detail to the embodiments of the present disclosure, examples of which are illustrated in the accompanying drawings. The present disclosure may, however, be embodied in many different forms and should not be construed as being limited to the embodiments set forth herein; rather, these embodiments are provided so that this disclosure will be thorough and complete, and will fully convey the concept of the present disclosure to those skilled in the art. Like reference numerals in the drawings denote like elements.

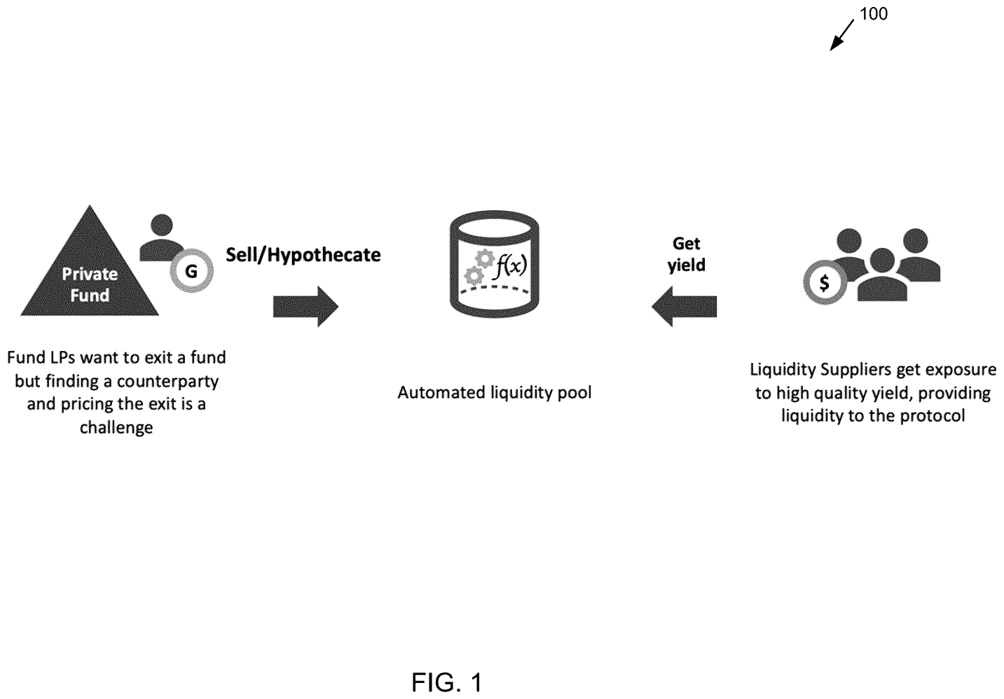

Referring now to FIG. 1, a liquidity transaction (e.g., liquidity transaction 100) consistent with embodiments of the present disclosure is provided. Liquidity transaction 100 may illustrate a typical interaction between a limited partner in a fund (LP) and a liquid capital holder, in the context of an automated liquidity pool (ALP) system (e.g., ALP 102). ALP 102 may offer a service that enables general partners (GPs) of private funds to setup a liquidity solution for illiquid assets, where the solution may be fully configurable, allowing each GP to define the parameters that best fit their individual needs.

In some embodiments, on one side of liquidity transaction 100 may be an institution or individual investor (e.g., LP 104) holding investment assets. On the other side of liquidity transaction 100 may be a liquid capital supplier (e.g., liquidity supplier 106) looking for stable, asset-backed yields for daily or short lock-up periods. Liquidity transaction 100 may show ALP 102 sitting between LP 104 and liquidity supplier 106, because ALP 102 may provide the means for executing the transaction.

ALP 102 may provide LP 104 with a reliable avenue for exiting their positions on their investment assets. Some of these investment assets may be highly illiquid, while others may be highly liquid. The investment assets may include things like securities, collectibles, real estate, private credit, private debt, real estate, infrastructure, private equity, venture capital, cryptocurrency, ETFs, tokenized RWAs, etc., and these assets may be tokenized or non-tokenized. Tokenized funds may represent LP 104's interest through tokens issued on a distributed ledger technology (DLT). These assets may be sold, traded, or hypothecated for token holders to access liquidity, as shown in liquidity transaction 100. The industry term for tokenizing assets may be RWA Tokenization, where RWA may stand for Real World Asset. ALP 102 may be specifically tailored to unlock liquidity for illiquid or semi-liquid instruments. Henceforth, in this disclosure, these financial assets and tokenized real-world assets may be referred to as “assets” regardless of whether they are implemented as actual tokens on a distributed ledger or as a digital representation of a conventional financial asset within a centralized or permissioned system, and regardless of what kind of asset they may represent. Financial assets here could include but are not limited to public and/or private securities, collectibles, real estate, private credit, private debt, infrastructure, private equity, venture capital, hedge funds, fund of funds, cryptocurrency, ETFs, Tokenized or non-tokenized RWAs etc.

In some embodiments, ALP 102 may also provide an avenue for liquidity supplier 106 to receive stable, asset-backed yields for daily or short lock-up periods. Lock-up periods may represent the minimum duration that a crypto depositor, like liquidity supplier 106, may be required to stay invested in ALP 102 before they may withdraw their holdings.

In some embodiments, ALP 102 may employ a two-layer discount structure to separate credit risk management from liquidity-driven pricing. A first-layer discount may be applied at the asset acquisition stage by the ALP manager to ensure that private assets may be priced appropriately based on their creditworthiness or valuation risk. This first layer discount may account for the intrinsic credit risk of the underlying assets and provide an initial buffer against potential impairments. A second layer discount may be managed through a pricing algorithm included in ALP 102, which may be adjusted dynamically based on the liquidity ratio of the liquidity pool. The liquidity pool may be a reserve of currency, capital and assets that enables automated, algorithmically priced buying, selling, or financing of real-world financial assets without requiring a traditional buyer-seller match. This second layer discount may be independent of credit risk and may instead ensure that LPs selling into the liquidity pool may be presented with a discount aligned with current liquidity conditions, allowing the system to self-balance liquidity incentives (yield to liquidity suppliers and discount to limited partners). Traditionally, pricing in liquidity transactions may require human participation, but ALP 102 may remove the need for human involvement by utilizing a system of computers, servers, databases, and user devices.

In some embodiments, investors/participants who hold fiat currency or other cash equivalents may also become liquidity suppliers, like liquidity supplier 106. Fiat assets may be assets that derive their value from government-issued (fiat) currency, rather than from a physical commodity like gold or silver. ALP 102 may coordinate with one or more trusted providers to convert fiat currency or other cash equivalents into stablecoins like USDC, or some other acceptable digital representation of assets within a permissioned and centralized system. This crypto-to-fiat (and vice versa) conversion process may be conducted through regulated service providers to ensure compliance with regulations and to allow fiat-based investors to interact with ALP 102 using fiat currency while the underlying system operates in stablecoins. Once the fiat currency is converted into stablecoins or some other acceptable digital representation of assets, they may then be provisioned into the liquidity pool under the same terms and conditions as any other stablecoin or acceptable digital representation of assets. Note, this merely presents an example using stablecoins, but ALP 102 may function using fiat currency as well.

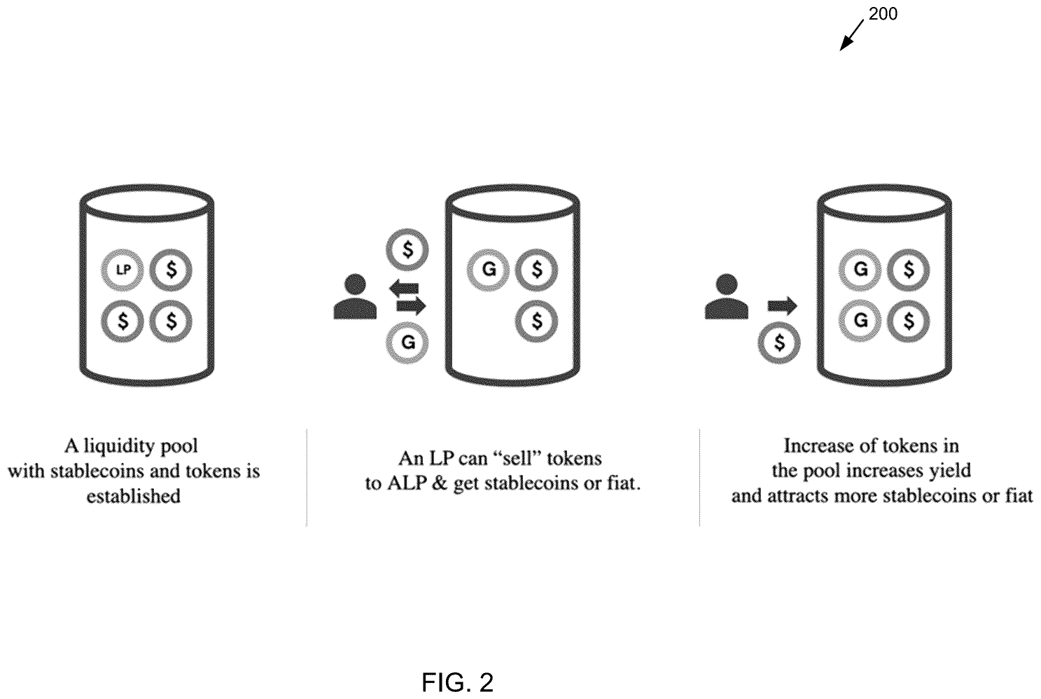

Referring now to FIG. 2, a liquidity pool (e.g., ALP liquidity pool 200) consistent with embodiments of the present disclosure is provided. ALP liquidity pool 200 may contain some liquid capital and some assets (the term token may be accurate as well as per the definitions in this document). An LP that owns some assets may desire liquidity and may sell their assets into ALP liquidity pool 200 and receive liquid capital in return.

In some embodiments, the ALP system may provide an avenue for liquidity suppliers to receive stable, asset-backed yields for short lock-up periods. Lock-up periods may be the minimum duration that a liquidity supplier may have to invest in the ALP system before they may take their holdings out from the ALP system. Liquidity suppliers may provision liquid capital like fiat currency directly to ALP liquidity pool 200, or other cryptocurrencies like Ethereum, Bitcoin, stablecoins etc. In such a situation, the ALP system may facilitate liquidity transactions, like hypothecating a crypto asset through a borrow/lend protocol where stablecoins or liquid capital may be borrowed and the received cryptocurrency may be deposited as collateral. Henceforth, such actors may be referred to as “stablecoin holders”, “USDC holders,” or “liquidity suppliers” interchangeably, given that pure cryptocurrency investments may also be allowed.

However, the incentive for depositors to provide additional liquidity may be better understood through the same example using a different layer of information.

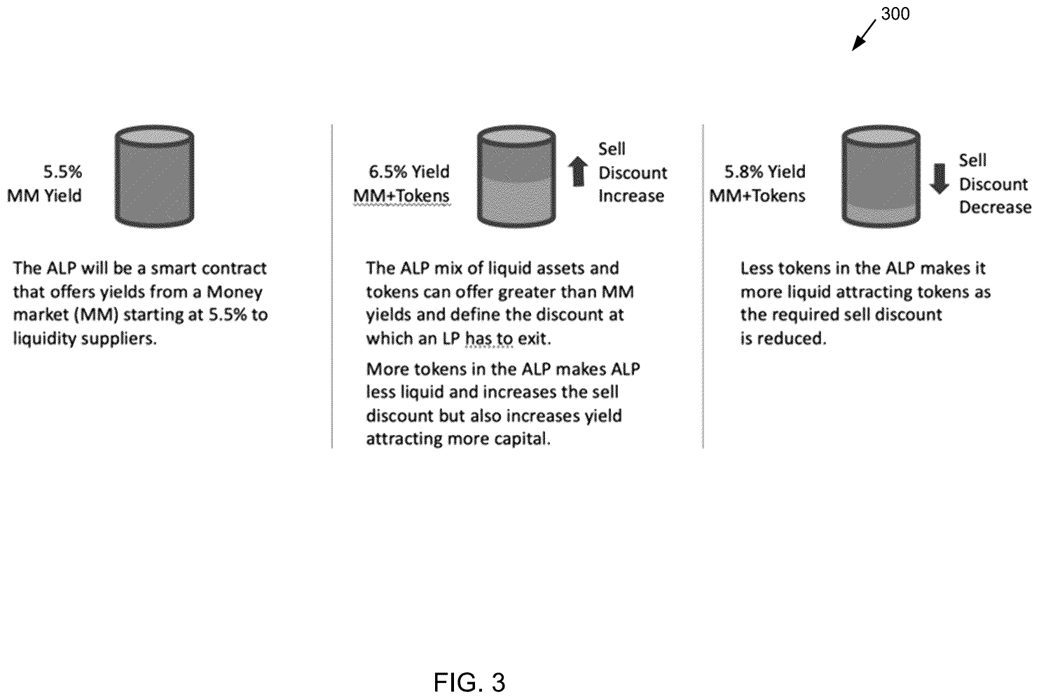

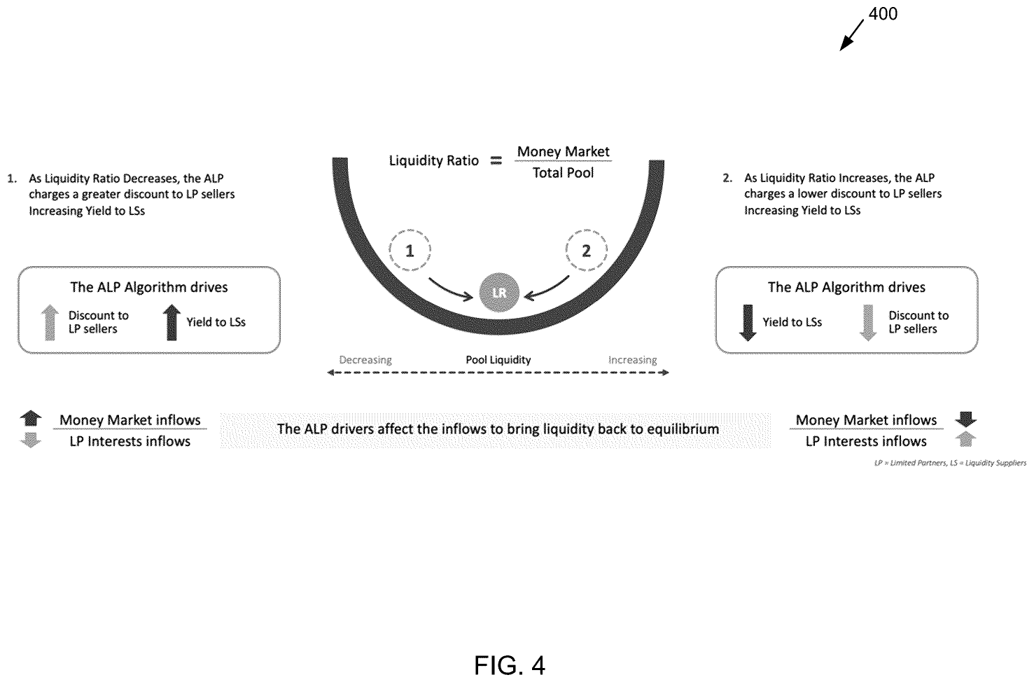

Referring now to FIGS. 3-4, a liquidity pool (e.g., ALP liquidity pool 300) and an example (e.g., example 400) illustrating the effects of an ALP algorithm on the liquidity ratio of an associated liquidity pool consistent with embodiments of the present disclosure are provided. Consider for example, a scenario where the liquid capital deposited into ALP liquidity pool 300 may be invested in the money market, such that at current rates, ALP liquidity pool 300 may yield 5.5% to the liquidity supplier, and the assets (and the term “tokens” may also be accurate as per the earlier definitions) may represent an asset that yields 10%, such that when an asset holder sells their asset into ALP liquidity pool 300, the average yield of ALP liquidity pool 300 may become more than 6.5%. At that point, the liquidity of ALP liquidity pool 300 may decrease as more assets are sold into it. However, introducing more assets to ALP liquidity pool 300 may also increase the yield, which may attract more liquidity suppliers and in turn make ALP liquidity pool 300 more liquid. Conversely, the ALP algorithm may calibrate the discount offered to the asset sellers. As shown in example 400, the more liquid ALP liquidity pool 300 becomes, the smaller the discount that the ALP algorithm may offer LPs selling their assets, and the less liquid ALP liquidity pool 300, the larger the discount the ALP algorithm may offer LPs selling their assets. Also, the discounted prices accepted by asset holders may add to the yield that the liquidity suppliers receive, so in extreme situations, the yield provided to liquidity suppliers may increase significantly. The inversely proportional relationship between the liquidity of ALP liquidity pool 300 and the size of the discount offered by the ALP algorithm may create a self-regulating system of incentives and disincentives for both liquidity seekers and liquidity suppliers. As liquidity is consumed, the cost of accessing it increases, discouraging overuse.

In some embodiments, the ALP system disclosed herein may offer liquidity for assets, which may represent assets in regulated industries, such that compliance may be of paramount importance for this system. Accordingly, know your customer (KYC) and anti-money laundering (AML) processes may be performed on both sides of the transaction. KYC/AML may be processes used by financial institutions to verify customer IDs and to prevent financial crimes.

In some embodiments, institutions or individuals willing to exit their position may deposit their asset into ALP liquidity pool 300 and in exchange may receive a matching stablecoin amount minus the first and second layer discounts (payout=asset value−1st discount−2nd discount−fees−expenses). The first layer discount, or “credit discount”, may account for the intrinsic credit risk or valuation risk of the assets, providing an initial buffer against potential impairments. The second layer discount may be determined by the ALP algorithm, based on a set of conditions including: (i) the current asset/stablecoin ratio in ALP liquidity pool 300, (ii) the value of the asset, (iii) the lockup period selected by liquidity suppliers, etc.

In some embodiments, the ALP algorithm may consider the amount of liquid capital deposited in the pool, alongside the different lockup periods that liquidity suppliers may have agreed on. Each of these deposits, along with the corresponding lockup period and share class, may be referred to as a “staking bucket” or a “liquidity bucket.” The total number of assets locked, and in the case of the asset being a debt asset, the principal and interest payment schedule of the underlying assets may be considered. Based on this liquidity availability, the ALP algorithm may provide the maximum number of assets that may be sold in exchange for liquid capital and the discount that the asset holder may accept, making sure that the lockup periods set by depositors (liquidity suppliers) may be honored.

In some embodiments, the liquid capital may be represented by stablecoins and these stablecoins may be off-ramped to fiat and invested in money market funds or other liquid assets to allow for higher liquidity, channeling back the yield in a pro-rata fashion to liquidity suppliers. Once an asset holder wishes to swap their assets for liquid capital, the liquid instruments may be sold to pay for the exit of the asset holder. From that moment onwards, liquidity suppliers may be exposed to the yield coming from the asset, such that ALP liquidity pool 300 may yield more than the initial return of a pure money market investment.

The liquid capital to asset ratio may be maintained in a healthy state since the liquidity of ALP liquidity pool 300 may be inversely proportional to the amount of assets being sold to the ALP. Liquidity suppliers may agree on a pre-defined lock-up period for the assets they deposit. As more asset holders wish to sell their assets into the ALP, ALP liquidity pool 300 may start approaching the yield provided by the assets, moving away from money market yields, and this may provide a more attractive investment opportunity to incentivize more liquidity suppliers, and thereby bring liquidity back into the ALP system and decrease the yield.

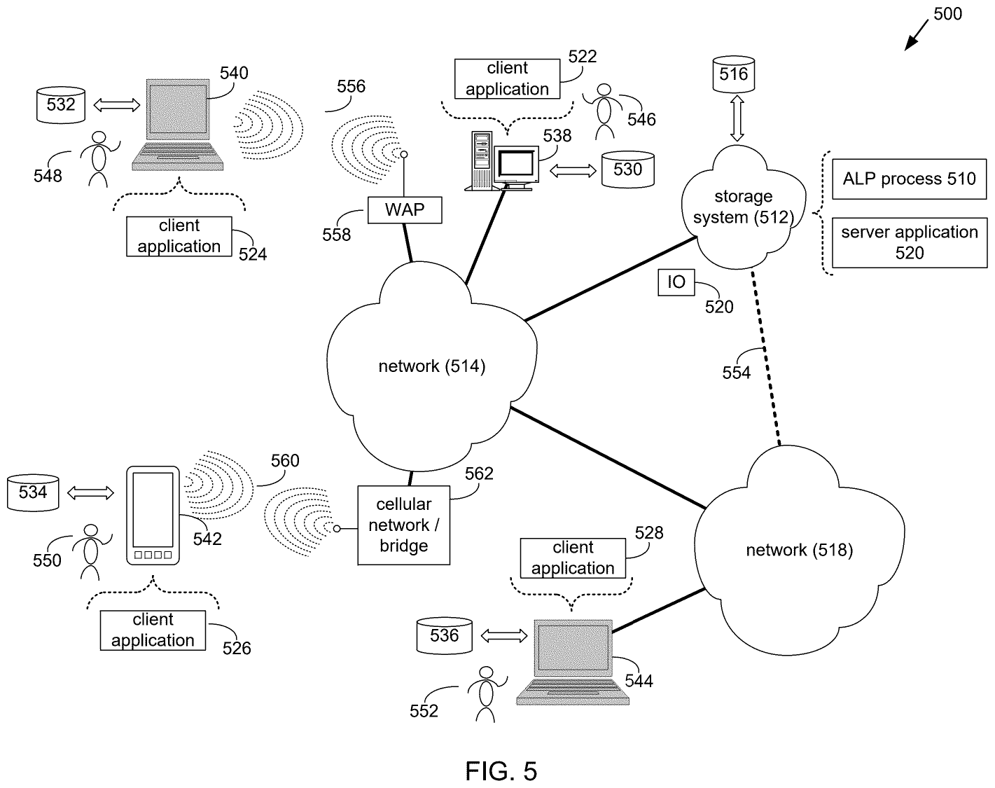

Referring now to FIG. 5, there is shown an ALP transaction process 510 that may reside on and may be executed by storage system 512, which may be connected to network 514 (e.g., the Internet or a local area network). Examples of storage system 512 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a mini computer, a mainframe computer, a RAID device and a NAS system. The various components of storage system 512 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of ALP transaction process 510, which may be stored on storage device 16 included within storage system 512, may be executed by one or more processors (not shown) and one or more memory architectures (not shown) included within storage system 512. Storage device 516 may include but is not limited to: a hard disk drive; a tape drive; an optical drive; a RAID device; a random access memory (RAM); a read-only memory (ROM); and all forms of flash memory storage devices. Additionally/alternatively, some portions of the instruction sets and subroutines of ALP transaction process 510 may be stored on storage devices (and/or executed by processors and memory architectures) that are external to storage system 512.

Network 514 may be connected to one or more secondary networks (e.g., network 518), examples of which may include but are not limited to: a local area network; a wide area network; or an intranet, for example.

Various IO requests (e.g. IO request 20) may be sent from client applications 522, 524, 526, 528 to storage system 512. Examples of IO request 520 may include but are not limited to data write requests (e.g., a request that content be written to storage system 512) and data read requests (e.g., a request that content be read from storage system 512).

The instruction sets and subroutines of client applications 522, 524, 526, 528, which may be stored on storage devices 530, 532, 534, 536 (respectively) coupled to client electronic devices 538, 540, 542, 544 (respectively), may be executed by one or more processors (not shown) and one or more memory architectures (not shown) incorporated into client electronic devices 538, 540, 542, 544 (respectively). Storage devices 530, 532, 534, 536 may include but are not limited to: hard disk drives; tape drives; optical drives; RAID devices; random access memories (RAM); read-only memories (ROM), and all forms of flash memory storage devices. Examples of client electronic devices 538, 540, 542, 544 may include, but are not limited to, personal computer 538, laptop computer 540, smartphone 542, notebook computer 544, a server (not shown), a data-enabled, cellular telephone (not shown), and a dedicated network device (not shown).

Users 546, 548, 550, 552 may access storage system 512 directly through network 514 or through secondary network 518. Further, storage system 512 may be connected to network 514 through secondary network 518, as illustrated with link line 554.

The various client electronic devices may be directly or indirectly coupled to network 514 (or network 518). For example, personal computer 538 is shown directly coupled to network 514 via a hardwired network connection. Further, notebook computer 544 is shown directly coupled to network 518 via a hardwired network connection. Laptop computer 540 is shown wirelessly coupled to network 514 via wireless communication channel 556 established between laptop computer 540 and wireless access point (e.g., WAP) 558, which is shown directly coupled to network 514. WAP 558 may be, for example, an IEEE 802.11a, 802.11b, 802.11g, 802.11n, Wi-Fi, and/or Bluetooth device that is capable of establishing wireless communication channel 556 between laptop computer 540 and WAP 558. Smartphone 542 is shown wirelessly coupled to network 514 via wireless communication channel 560 established between smartphone 542 and cellular network/bridge 62, which is shown directly coupled to network 514.

Client electronic devices 538, 540, 542, 544 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

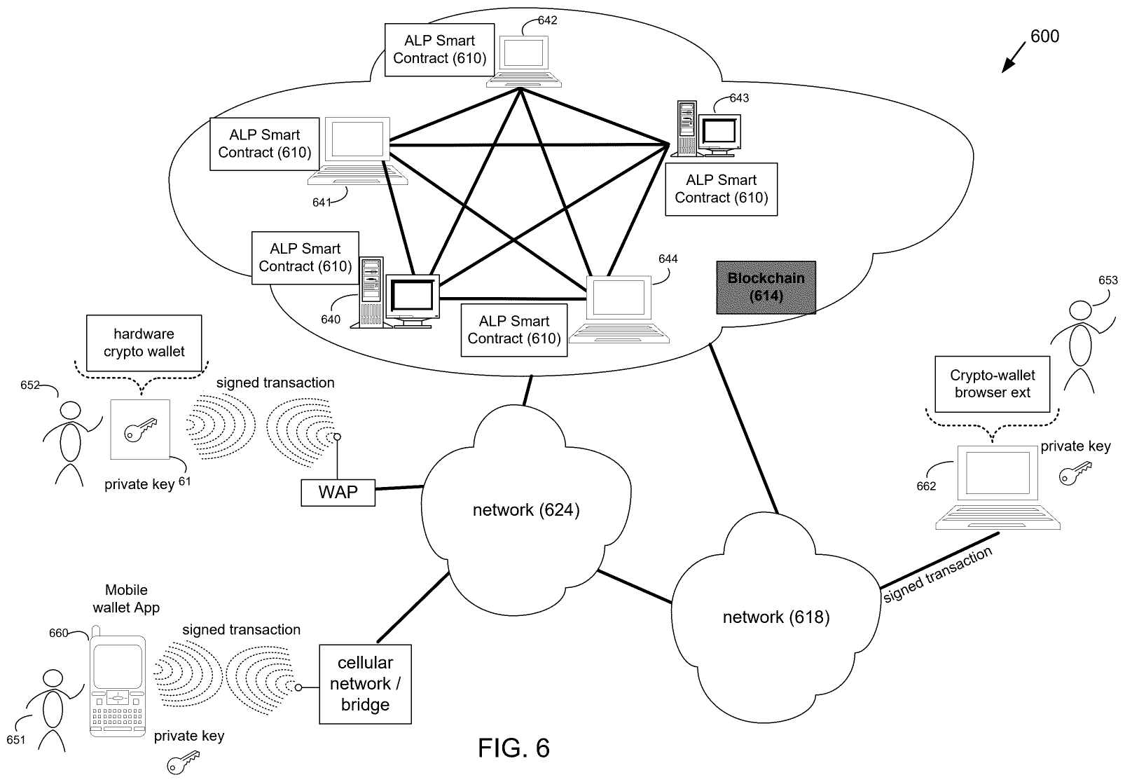

Referring now to FIG. 6, an ALP smart contract (e.g., ALP smart contract 610) deployed on a blockchain network (e.g., blockchain network 614) consistent with embodiments of the present disclosure is provided. Blockchain network 614 may be a public blockchain, private blockchain, hybrid blockchain, or consortium blockchain, enabling decentralized and trustless interactions. Blockchain network 614, upon which the ALP smart contract 610 may reside, ensures immutability and transparency for all transactions.

ALP smart contract 610 may be composed of instructions stored on the distributed ledger of blockchain network 614. These instructions may be executed by nodes in the network (640, 641, 642, 643, 644), which collectively maintain the state of ALP smart contract 610 and process transactions. The storage mechanism for the code and data of smart contract 610 may include, but is not limited to, decentralized storage solutions like IPFS or on-chain storage provided by the blockchain itself.

ALP smart contract 610 may facilitate decentralized exchanges and liquidity provision, which may enable users to engage in financial transactions without the need for intermediaries. Users 651, 652, 653 may interact with ALP smart contract 610 through decentralized applications (dApps) or directly via their wallets, which may include browser extensions, mobile applications, or hardware wallets. These interactions may be facilitated by blockchain network 614, which may connect client devices 660, 661, 662 (e.g., personal computers, smartphones, etc.) corresponding to users 651, 652, 653 respectively, to ALP smart contract 610.

ALP smart contract 610 may allow users to execute decentralized financial operations such as swapping assets, providing liquidity, or engaging in lending and borrowing activities. The logic used by ALP smart contract 610, including functions for calculating token prices, managing liquidity pools, and distributing fees, may be executed by the blockchain's consensus mechanism, that may ensure that all operations are performed transparently and according to a predefined set of rules defined in the contract.

In this decentralized system, nodes 640, 641, 642, 643, 644 of blockchain network 614, which collectively execute ALP smart contract 10, may operate on a variety of different operating systems. Nodes 640, 641, 642, 643, 644 may run on diverse platforms such as Linux, Windows, macOS, or even specialized blockchain OS environments, ensuring broad compatibility and flexibility within the network. This heterogeneity in operating systems may not hinder the operation of ALP smart contract 10, as the underlying blockchain protocol may standardize communication and execution across all nodes, regardless of their individual configurations. This cross-platform capability may be a key feature of decentralized networks, allowing participation from a wide range of hardware and software environments while maintaining the integrity and consistency of the blockchain ledger.

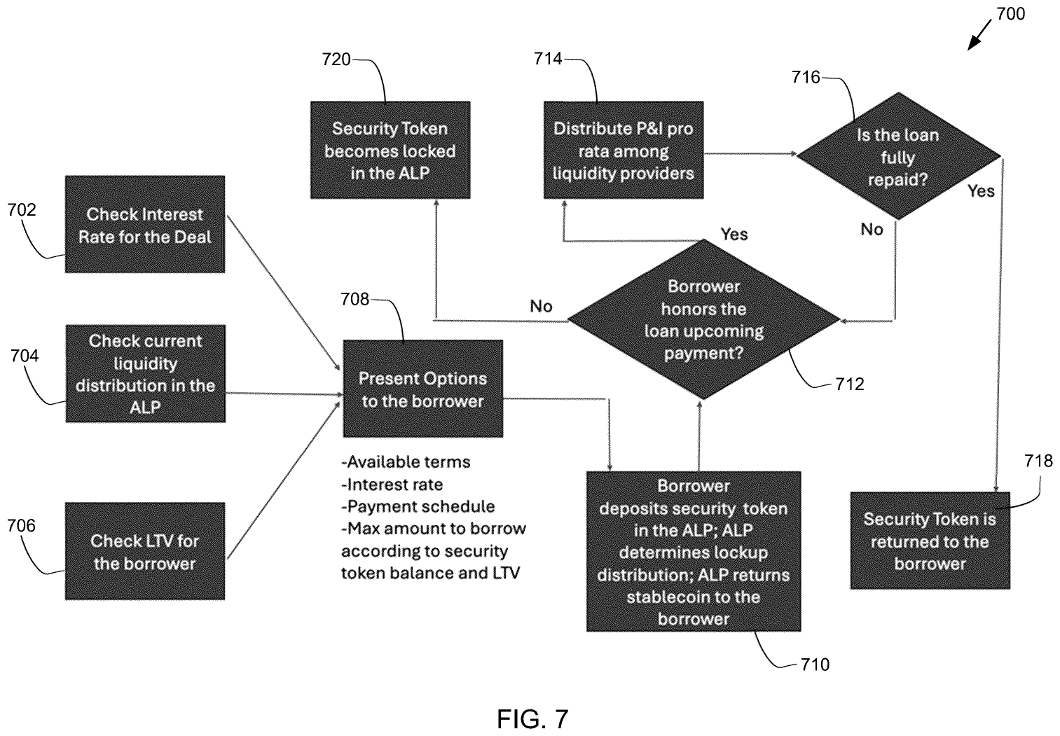

Referring now to FIG. 7, a flowchart depicting a liquidity transaction (e.g., liquidity transaction 700) consistent with embodiments of the present disclosure is provided. Liquidity transaction 600 may include checking (702) an interest for the transaction, checking (704) a current liquidity distribution in the ALP, and checking (706) a loan-to-value ratio (LTV) for a borrower. Liquidity transaction 700 may further include presenting (708) transaction parameters to the borrower, and depositing (710) a token (here token is an example, and the term “asset” may also be accurate) in the ALP, where the ALP may determine lockup distribution or return stablecoin (or liquid capital representation) to the borrower. Liquidity transaction 600 may also include confirming (712) that the borrower may have submitted payment for the most recent installment. In response to confirming that the borrower has submitted payment for a most recent installment, Liquidity transaction 700 may include distributing (714) a principal and interest pro rata allocation among liquidity suppliers, confirming (716) that any outstanding balance may have been fully repaid, and in response to confirming that any outstanding balance may have been fully repaid, returning (718) the token to the borrower.

In some embodiments, in response to confirming that the borrower has not submitted payment for a most recent installment, liquidity transaction 700 may further include locking (720) the token in the ALP, and in response to confirming that an outstanding balance has not been fully repaid, reconfirming (712) that the borrower may have submitted payment for the most recent installment.

In some embodiments, liquidity transaction 700 may assume that the token represents an underlying security, but the same process may be applicable for other types of assets.

In some embodiments, liquidity transaction 700 may be used in 2 different configurations: (i) repurchase agreement, and (ii) hypothecation. Under the repurchase agreement configuration, an asset may be deposited into an ALP liquidity pool, where the asset may be pledged as collateral under an agreement to repurchase it later at a higher price. Liquidity transaction 700 may be configured to funnel the dividends coming from the asset back to the lender or the borrower. Further, repurchase agreements may involve parameters like: (i) loan-to-value ratio (LTV), (ii) principal amount borrowed, (iii) collateral value of the asset provided as collateral, (iv) loan term/duration of the agreement, (v) implicit interest rate for the loan (repo-rate), and (vi) repurchase price to be repaid by the borrower, including an interest rate determined by the repo-rate.

In some embodiments, liquidity transaction 700 may be used under the hypothecation configuration, a asset may be deposited into the ALP liquidity pool, where the token may be pledged as collateral under the agreement to repay the loan according to a pre-defined payment schedule. Liquidity transaction 700 may be configured to funnel the dividends coming from the asset back to the lender or the borrower. Further, hypothecation agreements may involve parameters like: (i) loan-to-value ratio (LTV), (ii) principal amount borrowed, (iii) collateral value of the asset provided as collateral, (iv) interest rate for the loan, (v) repayment schedule for repaying the principal and interest.

In some embodiments, a different liquidity transaction may be used under a buying/selling configuration. Consider, for example, a scenario where an LP sells their asset into the ALP liquidity pool. In this scenario, liquidity transaction 700 may not be deterministically set up, but may instead use incentives like yields and discounts to control/maintain the liquidity of the ALP liquidity pool. The ALP system may then rely on factors like: (i) the payment schedule of the assets, (ii) estimates of forecasted deposit amounts, (iii) bucket creation frequency, (iv) the lockup period duration as set by liquidity suppliers, and (v) the amounts to be withdrawn from each bucket upon expiration.

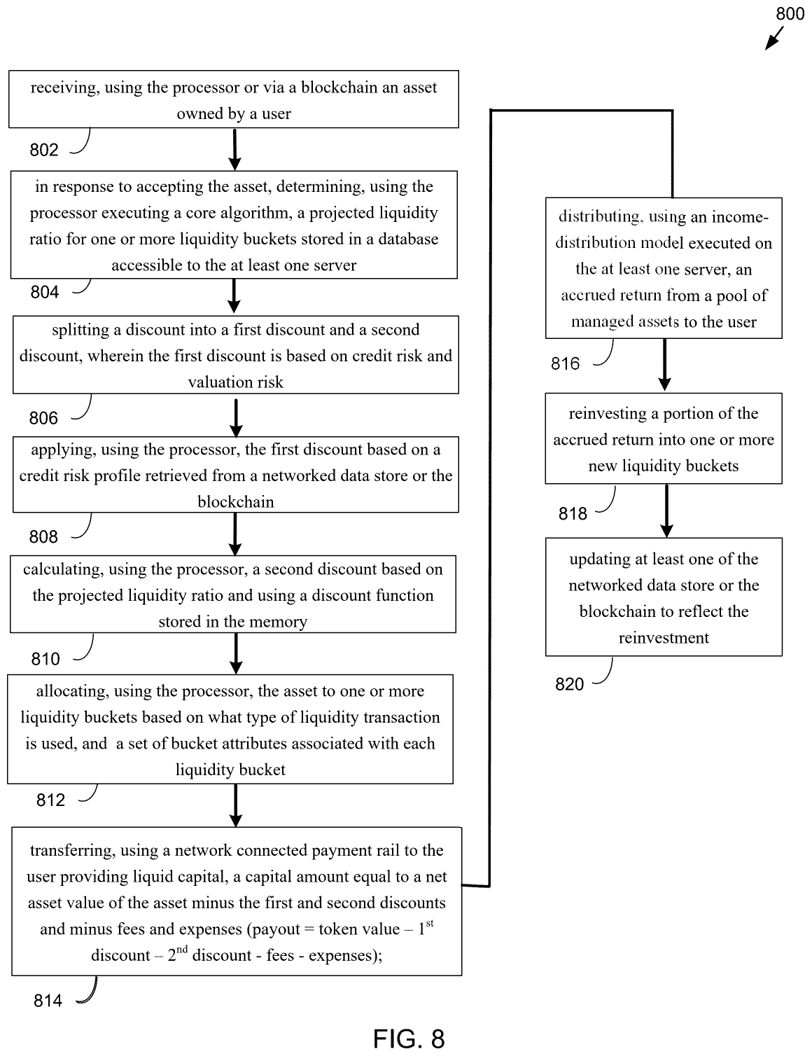

Referring now to FIG. 8 a flowchart depicting an ALP process (e.g., ALP process 800) consistent with embodiments of the present disclosure is provided. ALP process 800 may include receiving (802), using the processor or via a blockchain an asset (the term “token” may also be accurate as per the definitions in this document) owned by a user, in response to accepting the asset, determining (804), using the processor executing a core algorithm, a projected liquidity ratio for one or more liquidity buckets stored in a database accessible to the at least one server, and splitting (806) a discount into a first discount and a second discount, wherein the first discount may be based on credit risk and valuation risk, where the second discount may be based on liquidity risk. ALP process 800 may also include applying (808), using the processor, the first discount based on a credit risk profile retrieved from a networked data store or the blockchain, calculating (810), using the processor, a second discount based on the projected liquidity ratio and using a discount function stored in the memory, and allocating (812), using the processor, the asset to one or more liquidity buckets based on what type of liquidity transaction may be used, and a set of bucket attributes associated with each liquidity bucket, wherein the liquidity buckets are maintained in the database stored on the at least one server. ALP process 800 may further include transferring (814), using a network connected payment rail to the user providing liquid capital, a capital amount equal to a net asset value of the asset minus the first and second discounts and minus fees and expenses (payout=asset value−1st discount−2nd discount−fees−expenses), distributing (816), using an income-distribution model executed on the at least one server, a return from a pool of managed assets to the user, where the pool of managed assets may be stored in a digital asset registry accessible by the system, reinvesting (818) a portion of the return into one or more new liquidity buckets, and updating (820) at least one of the networked data store or the blockchain to reflect the reinvestment.

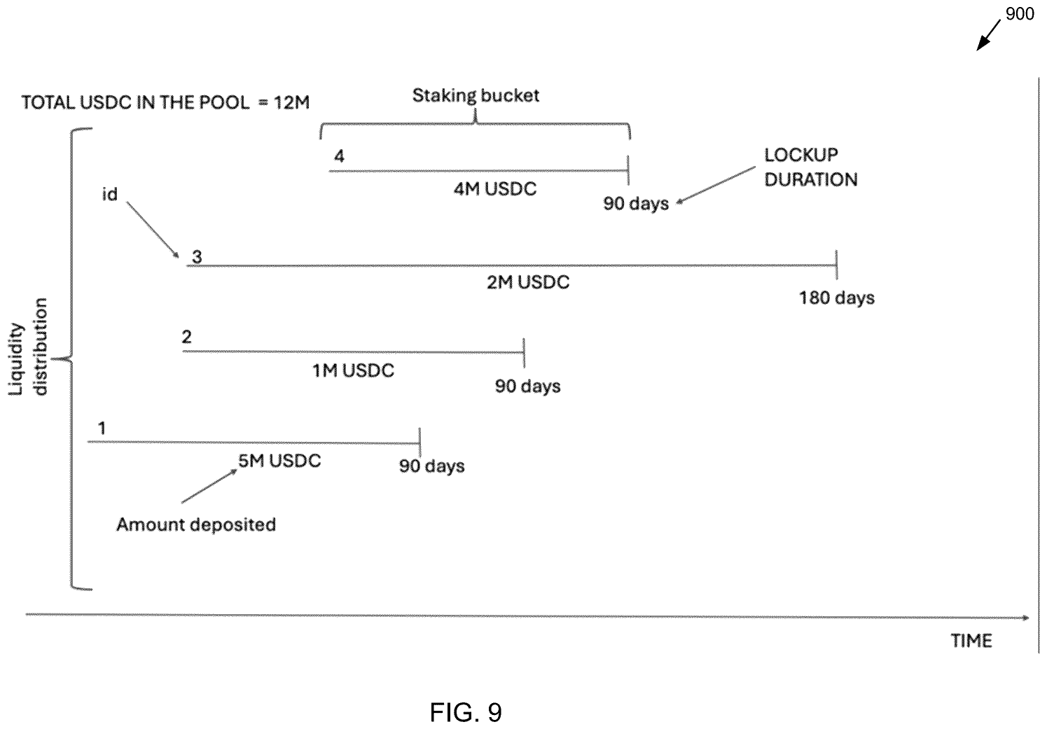

Referring now to FIG. 9, a line chart (e.g., chart 900) of a liquidity distribution over time consistent with embodiments of the present disclosure is provided. To ensure the ALP system has available liquid capital, liquidity suppliers may decide on the amount of capital they wish to deposit into the liquidity pool and select a lockup period. These lockup periods may be customized by the manager. These deposits may be placed into a staking/liquidity bucket (e.g., liquidity buckets 1-4), characterized by its creation date, lockup duration, and deposited amount. Chart 900 may show four liquidity buckets as an example (e.g., liquidity buckets 1, 2, 3, and 4). Liquidity bucket 1 may be created on a first date, have a lockup duration of 90 days, and include 5 million USDC (could be some other stablecoin or fiat currency) as the deposit amount. Liquidity bucket 2 may be created on a second date, sometime after the first date, have a lockup duration of 90 days, and include 1 million USDC as the deposit amount. Liquidity bucket 3 may also be created on the second date, have a lockup duration of 180 days, and include 2 million USDC as the deposit amount. Liquidity bucket 4 may be created on a third date, sometime after both the first and second dates, have a lockup duration of 90 days, and include 4 million USDC as the deposit amount. Altogether, these four liquidity buckets may have a liquidity distribution of 12 million USDC.

In some embodiments, the ALP system may operate using a combination of multiple algorithms configured to interact with each other, where each algorithm may be responsible for a specific aspect of the system's behavior. The core ALP algorithm may be structured around three key sub-algorithms: (i) the allocation algorithm, (ii) the income distribution algorithm, and (iii) the pricing algorithm. Together, these three components govern how liquidity may be allocated, how income may be distributed among liquidity suppliers, and how pricing may be dynamically adjusted based on real-time liquidity conditions. This modular approach may allow for flexibility in implementation, enabling an ALP manager or asset manager to tailor the behavior of the ALP liquidity pool according to the underlying asset structure, liquidity preferences, and yield objectives of the platform. The ALP manager, or asset manager of the ALP, may be responsible for setting the first layer pricing discount and for generally monitoring the behavior of the ALP system. The ALP manager may also select and configure the sub-algorithm implementation to be used in each liquidity transaction (i.e., the pricing, allocation, and income distribution algorithms). Each sub-algorithm may be implemented using a range of techniques, from simple heuristics to advanced optimization models, depending on the desired complexity and strategic goals.

In some embodiments, a position may represent the combination of all parameters required by the ALP system to execute a trade between an asset and liquid capital. The position may be determined by the type of liquidity transaction (i.e., repurchase agreement, hypothecation, or buy/sell), the amount of the asset, and the associated terms for each type of liquidity transaction, for example, the loan-to-value ratio (LTV), the principal amount, the duration, etc. Whenever a certain amount of assets needs to be deposited into the liquidity pool, the allocation sub-algorithm may determine the optimal allocation strategy for these assets. A fractional portion of the position may be deposited into different liquidity buckets to allocate the position entirely. Further, the allocation algorithm may be configured to ensure that the terms of all combined positions in the ALP liquidity pool may be honored. The allocation sub-algorithm may be implemented in a variety of ways, depending on the goals of the ALP manager and the nature of the liquidity transactions being executed. At a high level, the allocation sub-algorithm may govern how incoming LP interest may be matched against the available liquidity in the system.

In some embodiments, the allocation sub-algorithm may employ a pro rata allocation strategy, where assets may be distributed proportionally across all available liquidity buckets based on the current size of each bucket. This approach may result in identical liquidity ratios being distributed across all buckets, effectively treating the entire pool as a single, unified source of liquidity with a single liquidity ratio. Consequently, when using this approach, all liquidity suppliers may receive the same yield, since the system makes no distinction between maturity dates during allocation.

In some embodiments, the allocation sub-algorithm may employ more advanced allocation strategies depending on the type of liquidity transaction being executed. For example, true sale or hypothecation transactions may typically involve more extended holding periods, so the allocation sub-algorithm may selectively allocate assets to liquidity buckets having longer lockup durations. Conversely, repurchase transactions may normally be more short-term in nature, such that the allocation sub-algorithm may selectively allocate assets to liquidity buckets having shorter lockup durations. These more sophisticated strategies may result in non-uniform liquidity ratios across buckets. Consequently, liquidity suppliers in different buckets may experience different effective yields, depending on how frequently and intensively their capital is being utilized. The allocation sub-algorithm may be further optimized by using a range of techniques varying from simple heuristics to more complex methods, such as: (i) greedy optimization, which may select the most cost-effective bucket at each step based on predefined criteria, (ii) linear programming, which may globally optimize allocation across constraints, and (iii) priority-based rules, where certain buckets may be favored or excluded depending on the type of transaction, maturity needs, or asset class. Ultimately, the design of the allocation algorithm may serve as a control mechanism for liquidity distribution of the ALP liquidity pool, and each asset manager of an ALP liquidity pool may determine which one best serves their needs.

In some embodiments, the income-distribution sub-algorithm may be responsible for distributing the income generated by the ALP system to its participants. This income may be the result of interest accrual on public assets like money market instruments and ETFs, and also from the principal and interest payments on the underlying assets, as well as from realized discounts from asset holders transacting with the ALP system. Beyond simple distribution, the income-distribution algorithm may also be required to determine how to allocate this income across different lockup durations. For example, the income-distribution sub-algorithm may calculate the appropriate yield boost for participants who commit to more extended lockup periods, aligning incentives with the pool's liquidity needs. The income-distribution algorithm may also choose to reinvest a portion of the income to deepen overall liquidity, thereby creating new liquidity buckets that may later be used to provide liquidity for other assets. The illiquid portion of the ALP liquidity pool may consist of private credit assets, which may generate constant cash flows in the form of principal and interest payments that follow different payment schedules. Furthermore, whenever an LP sells into the pool at a discount, liquidity suppliers may be exposed to the private assets at a lower price than their nominal value. This discount may increase the effective yield of the investment. For example, suppose an LP sells its interest at a 50% discount. In that case, the interest payments received from the asset may be doubled in terms of percentage yield for the liquidity suppliers because they are receiving full interest distributions on assets they acquired at a fraction of the original value.

In some embodiments, principal repayments may be retained in the ALP to serve two key functions: (i) honoring future redemptions from liquidity suppliers so the system can pay them back their principal, and (ii) contributing to the liquidity buffer of the ALP liquidity pool, thereby ensuring its resilience over time. These discounted principal repayments may create a liquidity reserve that grows over time and reinforces the ALP liquidity pool's ability to handle withdrawals and mitigate the risk of running out of liquid capital. Since LPs may have originally sold their assets at a discount, the principal repayments may arrive in full to further strengthen the liquidity pool, as the system may effectively keep the discount as additional liquidity over time. The ALP system may employ a daily interest accrual mechanism to ensure that each liquidity supplier receives their fair share of interest payments from the underlying assets. The ALP system may track and accrue interest “entitlements” based on each liquidity supplier's fractional ownership of the liquidity pool at that moment, such that at any given time, the system may determine what proportion of the future interest payments belong to each liquidity supplier, even before the actual payment may have been received.

In some embodiments, unlike traditional fixed income instruments where interest may be accrued in fixed dollar amounts based on a predefined yield, the ALP system may not estimate or assume exact future interest payments. Instead, the ALP system may track the proportional entitlement of each supplier to the actual payments when they occur. Tracking these entitlements may avoid the risks of over- or under-accruing interest due to unexpected variations in asset performance, changes in payment schedules, or credit events affecting cash flows. When an underlying asset eventually makes its interest payment, the ALP system may distribute the proceeds exactly according to the daily accrued entitlements that have been tracked over time. This distribution may ensure that liquidity suppliers receive interest in direct proportion to their ownership and time commitment over the relevant period, independent of when the payment actually arrives. This distribution may also ensure that if a supplier exits the ALP liquidity pool before an interest payment is received, their accrued entitlement may remain tracked and may still be distributed to them once the payment is made. Tracking accrued entitlements like this may allow the ALP to function with precision and fairness, and ensure that interest earnings may be distributed exactly as they should be, without introducing estimation errors or timing risks. This yield, generated by the payments of the underlying assets, may not be predetermined or set by the ALP system. Instead, the yield may be an observed metric, calculated after the fact.

In some embodiments, when a liquidity supplier withdraws their funds, they may receive: (i) all interest payments that have already been received from the private assets until to that point, (ii) their original principal deposit, and (iii) any interest that has accrued but has not yet been received from the private credit assets may remain in the pool; however, the interest may still be paid to the withdrawing investor once it is received. Handling the accrued interest this way may ensure that liquidity suppliers do not miss out on earnings generated while their assets remain in the ALP system, even after they have exited their position. The ALP system may track which investors accrued interest during their time in the pool and may distribute those payments accordingly when they are received from the interest-paying assets, even when the liquidity suppliers have already exited their position. This mechanism may ensure fairness, as liquidity suppliers may not be penalized for mis-timing their withdrawals relative to the private credit asset payment schedules.

In some embodiments, to further incentivize liquidity provision, an ALP system may support multiple share classes with different terms, different maturities, different yields for liquidity suppliers. These classes (referred to as Class A, Class B, etc.) may allow the ALP manager to tailor terms to the preference of different types of liquidity suppliers. Each class may be structured to reflect distinct tradeoffs between liquidity and yield. For instance, one class may offer daily liquidity in exchange for a lower yield, while another may require a lock-up period in return for higher returns. This segmentation may enable the pool to attract a broader range of capital, accommodating the needs of both risk-averse and more risk-tolerant participants. The allocation of yield across classes and the liquidity terms associated with each class may be statically defined or dynamically adjusted in real-time through algorithmic mechanisms. For example, in a two share class structure, the ALP manager may implement a function to adjust the yield spread between Class A and Class B based on the current ratio of funds in each class.

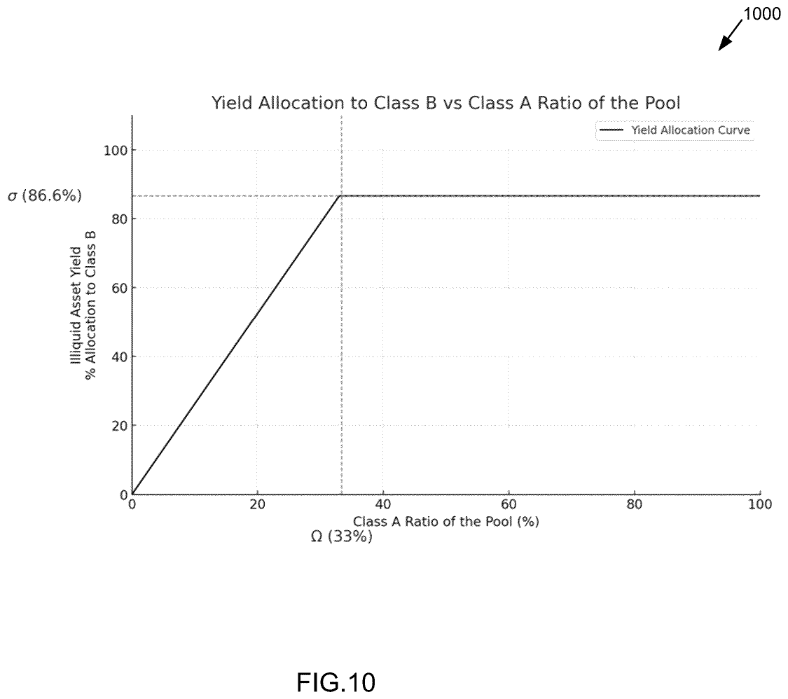

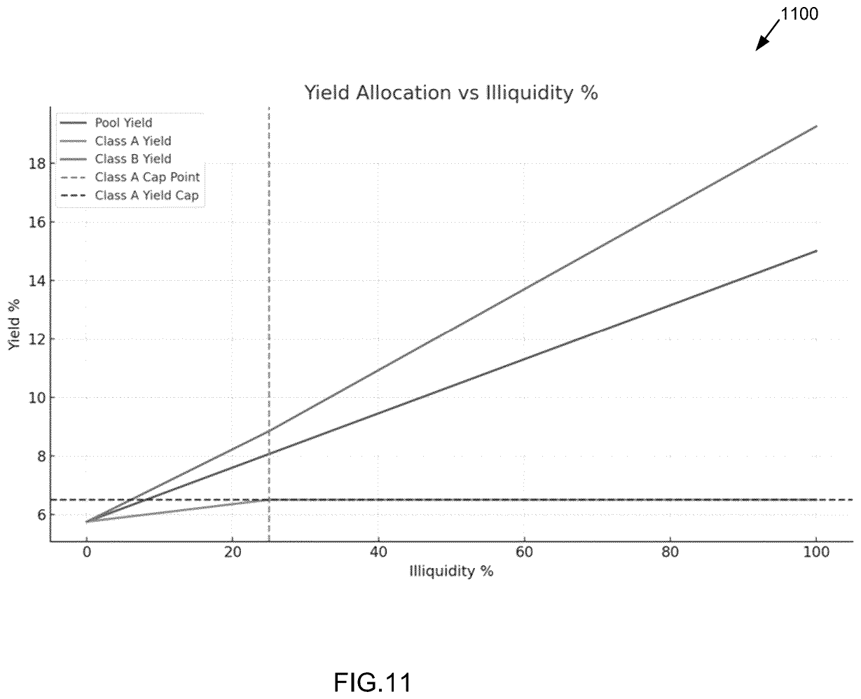

Referring now to FIGS. 10-11, a graph of yield allocation vs. class ratio (e.g., graph 900) and a graph of yield allocation vs. illiquidity (e.g., graph 1100) consistent with embodiments of the present disclosure are provided. Graph 1000 may illustrate a function governing the real-time relationship between the class A to class B ratio of investors in the ALP liquidity pool, and the proportional yield of the illiquid portion of the ALP liquidity pool that may be distributed to class B, as the class ratio changes. The function may be defined by two key parameters, sigma and omega. Sigma may dictate what max cap (upper limit) may be applied to class A yield exposure to illiquid assets yield (86.6% in this case). Omega may dictate the maximum ratio of class A participants in the pool until the cap is applied (33% in this case). Between Class A ratio 0 to Omega, the function may increase linearly, distributing more of the yield coming from illiquid assets to the class B investors until reaching the max cap.

In some embodiments, graph 1000 may produce an infinite amount of yield % to illiquid % functions, depending on the materialized yield % of the assets composing the pool. Consider, for example, if the ALP composition may include: money market assets that yield 4.5%, and an illiquid portfolio of the pools yields an average of 15%. This configuration of sigma and omega may cap class A at 200 bps over money market after class A is ⅓ of the total pool size or more, or 6.5% assuming the money market accounts for 4.5%. With this configuration of sigma and omega, class B may receive 86.6% of the total yield coming from illiquid assets after class A becomes ⅓ of the pool or more. Class A and Class B at 0% illiquidity may have the same yield. After the Class A cap, Class B may receive all the additional yield (13% in this case) over the money market value. Between 0% illiquidity and Class A cap (omega), the Class A yield may increase, and the Class B yield may also grow at a greater rate as the pool becomes more illiquid. Producing the yield curve shown in graph 1100 for a pool composed of 50% class A and 50% class B.

In some embodiments, the liquidity ratio (LR) of an n^{th} bucket may be defined as the ratio of liquid capital to the total value locked in the bucket, where n may represent the number of buckets varying from zero to i, such that 0<n<i. This ratio may range from 0% to 100%, indicating the extent to which each bucket may be constrained by its liquidity. LR may be given by Equation 1 below:

$$LR ( {bucket}_{i} ) = \frac{TVL ( {USDC}_{i} )}{TVL ( {USDC}_{i} ) + TVL ( Sec {Token}_{i} )} \qquad Equation 1$$

Where USDC may represent liquid capital, in this case a digital stablecoin tethered to the United States Dollar. This ratio may provide an insight into the composition of the liquidity bucket by indicating its liquidity health. A lower ratio may suggest a greater proportion of assets relative to liquid capital, while a higher ratio indicates a greater proportion of liquid capital relative to assets.

In some embodiments, the liquidity ratio may represent the independent variable fed into a discount curve function, and this discount curve function may return the discount to be applied to a specific liquidity bucket “i”, effectively quantifying the cost of accessing liquidity from that bucket. By mapping liquidity conditions to a pricing outcome, the discount function may play a central role in shaping incentives and preserving balance within the pool. By linking the discount directly to the liquidity ratio, the system may create a dynamic, self-adjusting market in which liquidity may become more expensive as it becomes scarce. Conversely, liquidity may also become cheaper as it becomes more abundant. This behavior may preserve the health of the ALP liquidity pool by discouraging excessive withdrawals during periods of low liquidity, while encouraging activity when capacity may be underutilized. Furthermore, this discount curve function may be implemented in various mathematical forms, depending on the desired behavior of the system.

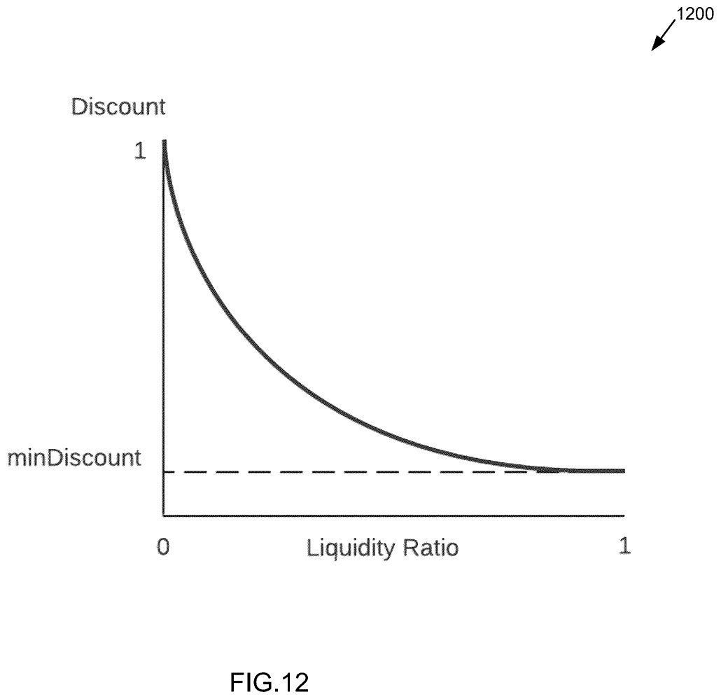

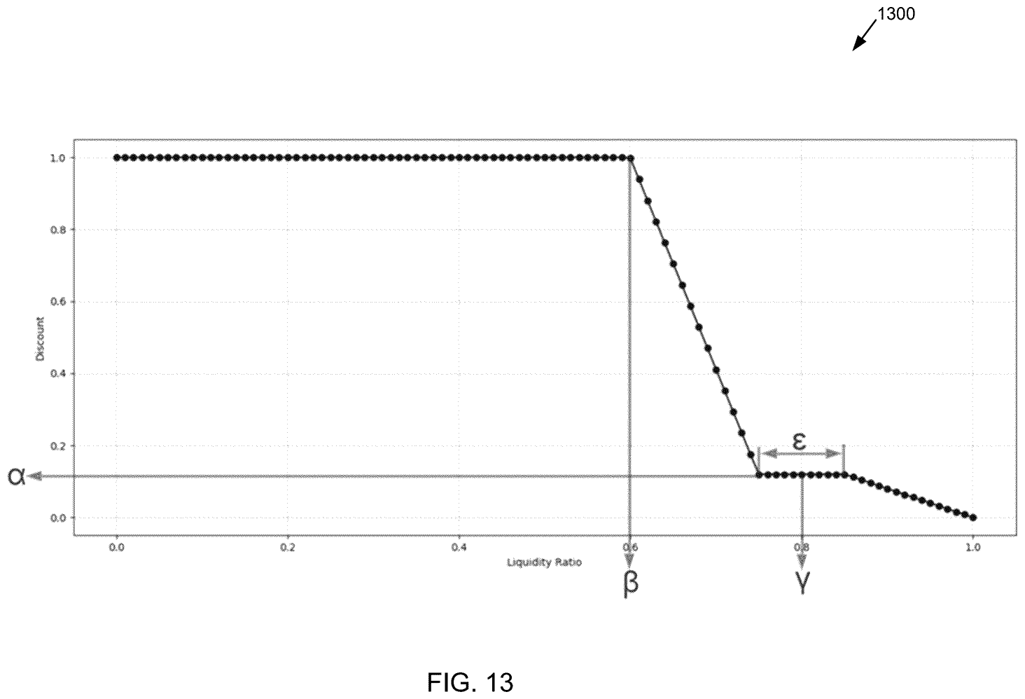

Referring now to FIGS. 12-13, plots for discount curve functions (e.g., plot 1200 and plot 1300) consistent with embodiments of the present disclosure are provided. Plot 1200 may represent a discount curve function modeled using an exponential decay function. The exponential decay function may be expected to span a wider domain (ideally [0, ∞)), but the LR may only range from 0 to 1. A mapping expansion (e.g., a logarithmic or inverse transformation) may be necessary to preserve sensitivity and ensure meaningful decay behavior. The LR value fed into the discount function may not be the current liquidity ratio of the bucket, but rather the projected liquidity ratio that would result if the position were accepted. Consider, for example, a bucket that currently holds $100 and is fully liquid (LR=100%). If a transaction for $40 is being evaluated, the function may use LR=60% (i.e., the resulting liquidity ratio after allocating the $40) when computing the applicable discount. This forward-looking approach may ensure that the cost of liquidity properly reflects the impact of the proposed transaction.

In some embodiments, the discount that an asset depositor may be required to accept in order to utilize a liquidity bucket may be given by Equation 2 below:

$$Discount ( LR ) = ( 1 - min Discount ) {e}^{- \frac{LR}{k}} + min Discount \qquad Equation 2$$

Where “Discount (LR)” may be the discount at a given projected liquidity ratio LR, minDiscount may be the minimum discount value (e.g, 0.02), which is a configurable parameter, and k may be a constant used to determine the rate of decay of the function, where K may be adjusted according to market conditions.

In some embodiments, the discount curve function of plot 1200 may return a discount of 1 (100%) when the liquidity ratio of the bucket is 0. Conversely, the discount curve function of plot 1200 may asymptotically approach the minimum discount as the LR of the bucket tends to 100%. According to plot 1200, the LR curve may represent the liquidity bucket utilized in the allocation of the position as determined by the allocation algorithm for each bucket.

In some embodiments, an ALP manager may prefer to actively guide the liquidity dynamics of the ALP liquidity pool, especially when the underlying assets or investor expectations may require more structured behavior. In such cases, a simple exponential discount curve may not provide sufficient control or predictability. To address these cases, an alternative discount function may be applied. As shown in plot 1300, a “4-Greeks” function may be used to introduce a stable pricing region, where the discount may remain constant and sharp penalties may be imposed outside that region to discourage undesirable liquidity extremes. The 4-Greeks model may be beneficial for ALP managers who have a clear view on where liquidity should be maintained and who want to create predictable pricing for both LP interest sellers and more predictable yield for liquidity suppliers. The 4-Greeks model may allow the ALP liquidity pool to absorb moderate liquidity fluctuations without changing incentives, while strongly discouraging behavior that would push the system into undesired states of illiquidity or overcapitalization. The 4-greeks function may be primarily defined by four parameters: α, β, γ, and ϵ, where α may be an intended stable discount, β may be a minimum liquidity threshold, γ may be an intended stable liquidity ratio, and ϵ may be a width of the stable discount LR region.

The formal definition of the function in plot 1300, for 0<=LR<=β may be given by f(LR)=1. For β<LR<=(γ−(ϵ/2)), the function in plot 1300 may be given by Equation 3 below:

$$f ( LR ) = 1 + \frac{α - 1}{( γ - ( ε / 2 ) ) - β} \cdot ( LR - β ) \qquad Equation 3$$

For (γ−ϵ/2)<=LR<(γ+(ϵ/2)), the function in plot 1300 may be given by f(LR)=α. For (β+(ϵ/2))<LR<=1, the function in plot 1200 may be given by Equation 4 below:

$$f ( LR ) = α - \frac{α}{1 - γ - ε / 2} \cdot ( LR - γ - ε / 2 ) \qquad Equation 4$$

In some embodiments, the intended stable discount (α) may be the discount sellers pay when the liquidity ratio of the ALP liquidity pool falls into the intended operation boundaries. Intended stable discount (α) may also affect the total yield offered by the ALP to liquidity suppliers. Hence, the value of intended stable discount (α) may be key to matching the expectations of both LP interest sellers and liquidity suppliers. To determine this parameter, the general partner (GP) may be required to define a target yield that they want to achieve. This yield should be enough to attract liquidity deposits when the system may be stable. This target yield expectation may be determined in various ways, of which some may be more quantitative, while others may be more qualitative. Consider, for example, one proposal to calculate the intended stable discount (α) may be to derive it from a Yield to Liquidity curve that may be used as a reference. This Yield to Liquidity curve may allow for a comparison of the yield offered by similar liquid assets/funds and publicly available data on them. However, before applying this approach, the ALP manager or investor may first ensure that: (i) they have a basis for bucketing assets/funds in a liquidity bucket, (ii) the data in use may be publicly available, and (iii) the chosen yield may be formulaic and not subjective. Additionally, the yield to liquidity relationship may change as macroeconomic conditions change, and the intended stable discount (α) may adapt accordingly. The yield to liquidity relationship may be a lagging indicator, hence the need to keep a safety buffer. In this example, it may be assumed that the yield of the liquid and illiquid portions of the pool may be constant, but that they may fluctuate over time. Since these may be floating-rate instruments, fluctuations in the spread over the reference rate (in most cases this may be the money market rate) may first need to be considered. Once verified, the ALP manager may decide on how frequently the alpha parameter should be updated to reflect those changes. Once the target yield (Y_{T}) is defined, the intended stable discount (α) may be given by Equation 5 below:

$$α = \frac{{Y}_{T} - γ \times {Y}_{L}}{( 1 - γ ) \times {Y}_{I}} \qquad Equation 5$$

Where Y_{T} may be the target yield for the ALP liquidity pool, γ may be an intended stable liquidity ratio, Y_{L} may be the liquid portion of the portfolio, and Y_{I} may be the illiquid portion of the portfolio. Consider for example, if the target yield expectation to liquidity suppliers is 7.5%, then the desired liquidity to illiquidity balance may be at 80% liquidity and the liquid portion of the pool yields 6.2% and the illiquid portion of the pool yields 12% (assuming a reference base rate of 5%), such that {0.075−(0.8*0.062)}/(0.2*0.12) may result in an intended stable discount of α=0.058.

In some embodiments, if the intended stable discount (α) is high in relation to the interest of LP sellers expectations, then the LP may not accept the trade, the liquidity ratio may be high when compared with the intended stable liquidity ratio (γ), such that the ALP liquidity pool may not reach the target yield (Y_{T}) and liquidity suppliers may lose their interest to invest. If the intended stable discount (α) is low in relation to the interest of LP sellers' expectations, then the LP may accept more deals, and the actual stability point may fall to a liquidity ratio point below γ. This dynamic may create more yield for liquidity suppliers, even surpassing the target yield (Y_{T}). Suppose the stability point is near the intended stable liquidity ratio. In that case, the extra yield may act as an incentive for new liquidity suppliers, and the ALP liquidity pool may reach a self-regulating balance. However, suppose large volumes of LP interest deals are traded, and the actual stability point becomes low. In that case, liquidity risk may become too high, thereby discouraging new liquidity suppliers from engaging with the ALP and further draining liquidity from the pool. Suppose the intended stable discount (α) value matches exactly the expectations for the LP interest sellers, and the target yield (Y_{T}) at the intended stable liquidity ratio (γ) is compelling for liquidity suppliers. In that case, the ALP system may produce optimal results. Qualitative analysis and market research may be crucial in order to determine the optimal value for the intended stable discount (α).

In some embodiments, the minimum liquidity threshold (β) may set the minimum liquidity ratio (LR) at a level below which LP sales may be completely disincentivized by imposing a 100% discount. In effect, the minimum liquidity threshold (β) may be used to determine the remaining liquidity in the ALP system. Some liquidity suppliers may be willing to fully expose their position if the yields justify the risk, while others may prefer a guaranteed liquidity buffer. Suppose the minimum liquidity threshold (β) is set to 0. In that case, the ALP may impose no minimum liquidity ratio, allowing the system to become fully illiquid, which may be very attractive to investors chasing higher returns despite full illiquidity risk. In an ideal scenario, where net inflows exceed or match outflows, the minimum liquidity threshold (β) may remain minimal, keeping withdrawals smooth. However, future liquidity may remain unpredictable. Some suppliers may favor this setup for higher returns without artificial constraints on capital allocation, making it best for investors comfortable with long-term lockups in exchange for enhanced yield. Conversely, setting a minimum liquidity threshold (β) at 60% may ensure that at least 60% of liquidity remains, preventing LP sales below that threshold and providing a conservative capital reserve during stress. This configuration may suit investors who want exposure to illiquid assets but need a measure of liquidity access, even if it constrains yield potential. In theory, a perfectly functioning ALP in a well-connected market environment could operate with an extremely low minimum liquidity threshold (β), enough to make sure that withdrawals may not be affected. If net inflows consistently exceed outflows, then the system may remain liquid without the need for a forced threshold. However, due to the unpredictability of liquidity flows, a buffer may still be necessary. A lower minimum liquidity threshold (β) may maximize return potential for those comfortable with periods of illiquidity, while a higher minimum liquidity threshold (β) may appeal to investors who prioritize stability. Initially, the minimum liquidity threshold (β) may be set based on qualitative analysis to provide a safety threshold for withdrawals. Over time, it may be dynamically adjusted based on liquidity flow patterns.

In some embodiments, the minimum liquidity threshold (β) may be given by Equation 6 below:

$$β = max ( k , ( 1 + k ) \frac{Δ CF}{{AUM}_{L}} ) \qquad Equation 6$$

Where ΔCF may be the difference between the total outflow and the total inflow (Total Outflows−Total Inflows), AUM_{L} may be the ALP liquid assets under management, and k may be a minimum buffer size. Analyzing some examples; for small relative net outflows and considerable net outflows may generate two different values of β according to the formula defined above. In one example, β=max (0.5, (1.5) 1.2 M/106.4 M)=max (0.5, 0.016)=0.5. In another example, β=max (0.5, (1.5) 143.6 M/106.4 M)=max (0.5, 0.61)=0.61.

In some embodiments, the intended stable liquidity ratio (γ) may define the center of the stable pricing region in plot 1300, acting as a target liquidity level where the ALP system may aim to maintain balance. At this liquidity ratio, the discount may remain fixed rather than following a steep increase or decrease, and may provide a predictable exit price for LPs. By setting up this configuration, a GP (general partner) may effectively determine the point at which liquidity conditions may stabilize before transitioning into more aggressive discounting on either side of the curve. This may be useful for funds that want to anchor liquidity around a specific level because of the liquidity risk tolerance of their liquidity suppliers, ensuring that LPs and liquidity suppliers interact within a controlled range rather than pushing the system toward more extreme illiquidity or excess liquidity. While some GPs may prefer a fully dynamic pricing model, others may see this parameter as a mechanism to create a more structured and intentional liquidity environment.

In some embodiments, the intended stable liquidity ratio (γ) in conjunction with the width of the stable discount-LR section (ϵ) may determine the intended operation boundaries for the ALP. The value of the intended stable liquidity ratio (γ) may always be between the minimum liquidity threshold (β) and 1 (100%). The hard cap for the liquidity risk may always be fixed by the minimum liquidity threshold (β), and the target yield (Y_{T}) may be the liquidity ratio where the ALP liquidity pool stabilizes under normal operating conditions. In the relationship between γ, α, and the target yield for the ALP (Y_{T}), assuming a fixed target yield (Y_{T}), if the target yield (Y_{T}) is increased, then the intended stable discount (α) may also need to be increased. Otherwise, if the intended stable liquidity ratio (γ) is decreased, then the discount asked of LP interest sellers (α) may also be reduced. Consider, for example, a fixed value for α=0.1 and β=0.6, such that the liquid portion of the ALP liquidity pool yields 6.2%, and the illiquid portion of the ALP liquidity pool yields 12%. Then the approximated total return offered by the ALP, assuming a stable operation, may be given by Equation 7 below:

$$Yield \approx ( 1 - γ ) \times ( 1 + α ) \times {Y}_{I} + γ \times {Y}_{L} \qquad Equation 7$$

Where γ may be the intended stable liquidity ratio, a may be the intended stable discount, Y_{I} may be the illiquid portion of the portfolio, and Y_{L} may be the liquid portion of the portfolio. The approximated total return offered by the ALP, assuming a stable operation, may change based on γ according to this function. For γ=0.8, Yield≈(1−0.8)×(1+0.1)×0.12+0.8×0.062≈7.6. For γ=0.9, Yield≈(1−0.9)×(1+0.1)×0.12+0.9×0.062≈6.9. For γ=0.7, Yield≈(1−0.7)×(1+0.1)×0.12+0.7×0.062≈8.3.

In some embodiments, the width of the stable discount LR region (ϵ) may be used to determine the range of liquidity levels for which the discount remains fixed before transitioning into a steeper adjustment. In other words, the stable discount LR region (ϵ) may represent the asset size that the ALP may be willing to absorb without significantly altering the discount. Suppose the stable discount LR region (ϵ) is set to 0. In that case, the discount pricing curve may become fully dynamic, such that every change in the liquidity ratio may immediately affect the discount, and eliminate any stable region. In this scenario, the intended stable liquidity ratio (γ) may become irrelevant since there is no predefined balance zone. These conditions may create pure market-driven pricing, where LPs and liquidity suppliers naturally find equilibrium through their trading activity. Aggressive selling may increase the discount quickly to discourage further sales, while abundant liquidity may reduce the discount to incentivize more LP sales. Since there may be no forced stability range, the system may be entirely responsive to real-time liquidity conditions without any built-in assumptions about where balance should be maintained. This approach may work best in high-activity systems, where liquidity may flow continuously and price discovery may be frequent. In low-activity environments, the lack of a stability zone may trigger abrupt discount price swings, increasing volatility and deterring participation. However, with steady LP trading and deposits, it enables efficient, real-time price discovery without arbitrary constraints, creating a truly neutral, market-driven system. Conversely, an intermediate stable discount LR region (ϵ) value may introduce a buffer around γ, establishing a controlled zone where the discount may remain fixed before moving into more pronounced adjustments. This intermediate stable discount LR region (ϵ) value may create a balance between market efficiency and intervention, providing LPs with a predictable exit window while still allowing dynamic pricing outside this range. Unlike ϵ=0, where the market fully controls equilibrium, a moderate, stable discount LR region (ϵ) may subtly bias liquidity toward a target range. By preventing discount fluctuations within this zone, the ALP fosters stability and may reduce price impact, which could be better for moderately active markets where constant liquidity shifts could unsettle existing LPs. However, ϵ may not be set too high, or it may risk weakening incentives for liquidity suppliers. With ϵ=10%, this issue may be mitigated because the stability zone may be large enough to provide predictability but not so large that it affects the ALP system's responsiveness. Plot 1300 may adjust when liquidity moves outside the stability region, ensuring that liquidity suppliers may be compensated as liquidity conditions change (favorably or unfavorably). Suppose a stable discount LR region (ϵ) is set too high, covering a large portion of the liquidity ratio range. In that case, the ALP may become too rigid, reducing its ability to respond to real-time liquidity ratio movements. On the extreme, a e of 100% may result in the discount being fixed for all liquidity levels, removing the natural market-driven price discovery that smaller e values allow. While this extreme setup may maximize predictability, it may also eliminate incentives for liquidity suppliers to respond to liquidity fluctuations. Since discounts do not change based on liquidity conditions, liquidity suppliers may not see an increase in yield even as liquidity decreases, which in turn may compromise the self-regulating mechanism of the ALP and potentially lead to situations where liquidity dries up. This configuration may suit highly institutionalized markets where GPs prefer complete pricing control, but in systems with frequent liquidity fluctuations, a moderate, stable discount LR region (ϵ) (like 10%) may be optimal, offering predictability without compromising responsiveness.

In some embodiments, once the discount curve is applied, whether as the exponential decay model in plot 1200, the four-Greek configuration in plot 1300, or using some other approach, the resulting value may determine the base discount per liquidity bucket. This base discount may then be used to calculate the final discount that an LP position may be required to accept. The total discount applied to a position may be calculated as the area under the discount curve, integrating the discount rate function from the original liquidity ratio (the current state of the bucket) to the projected liquidity ratio that would result if the trade is accepted. This approach may capture the full impact of the transaction on the system's liquidity, rather than just applying the discount rate at a single point. By integrating over the range [LRorigin, LRprojected], the model may account for how the marginal cost of liquidity changes throughout the span of the trade, ensuring that larger transactions (which move the liquidity ratio further) may be appropriately penalized through a higher cumulative discount, such that the total discount applied may be given by Equation 8 below:

$$Discount = {\int }_{LR}^{pLR} f ( x ) dx \qquad Equation 8$$

Where f(x) may be either the 4-greeks function or the exponential decay function, whichever one is selected, and this discount may be calculated for each liquidity bucket, such that the total discount that the position may be required to accept percentage-wise may be given by Equation 9 below:

$$Discount ( p ) = \frac{{\sum }_{i = 0}^{n} Discount ( LR ( i ) ) * GATAmtLocked ( p , i )}{{\sum }_{i = 0}^{n} GATAmtLocked ( p , i )} \qquad Equation 9$$

Where this sum may represent the sum of all the discounts among all the buckets utilized by the allocation algorithm for the position “p”, LR(i) may be the liquidity ratio of bucket “i”, Discount (LR(i)) may be the discount function defined in the section above, and GATAmtLocked(p, i) may represents the total amount of assets allocated for the bucket i for the position p.

Finally, the total bid offered by the ALP for the position “p” may be given by Equation 10 below:

$$Bid ( p ) = ( 1 - Discount ( p ) ) * TQ ( p ) * \frac{NAV}{token} \qquad Equation 10$$

Where TQ(p) may be a function that returns the amount of assets for the position “p”, and NAV may be the net asset value, where the NAV per asset unit may be fed into the ALP system externally.

In some embodiments, the Automated Liquidity Pool (ALP) introduced in this invention may offer significant improvements over traditional mechanisms for managing liquidity in private market assets and may also offer a more liquid investment paradigm for a broader range of investors. By decoupling credit risk and liquidity risk pricing and introducing a modular, algorithmically governed infrastructure, the ALP system may benefit a wide array of participants across the private investment ecosystem:

In some embodiments, investors may access yield tiers above money market benchmarks, with Class A offering daily liquidity at a lower yield and Class B offering higher yields with quarterly liquidity and lockups. This structure may allow capital allocators to choose risk-adjusted liquidity profiles while accessing private market exposure.

In some embodiments, the ALP may have private equity assets and may also include equity share classes. The share classes may have different rights to participate in the returns from different portions of the assets in the pool.

In some embodiments, smaller investors may access institutional-grade private credit/equity funds with minimums as low as $10,000, broadening market participation. An ALP can also accept smaller ticket sizes if the legal structure used permits it.

In some embodiments, institutional or retail allocators (e.g., family offices, insurers) may deploy capital temporarily with the ability to earn yield while waiting for capital calls or rebalancing.

In some embodiments, LPs may exit their fund positions far faster than traditional secondaries, potentially within days instead of the current time, which can be months, without relying on bilateral matchmaking.

In some embodiments, algorithmic, pool-based pricing based on liquidity ratio modeling (e.g., exponential decay, 4-Greek curve) may allow for more accurate, less punitive exit discounts.

In some embodiments, LPs with smaller investment positions, which may typically be ignored by traditional secondary buyers, may now access liquidity.

In some embodiments, discounts and pricing mechanics may be published on-chain, replacing opaque negotiation with real-time programmatic pricing.

In some embodiments, GPs may offer shorter-duration access to private funds across new channels, retail platforms, stablecoin ecosystems, and digital wallets, without needing separate share classes or separately managed accounts (SMAs).

In some embodiments, GPs may monetize liquidity provisioning through management fees on ALP transactions or liquidity spread margins.

In some embodiments, ALPs may offer an alternative to side pockets, continuation funds, fund extensions, or forced asset liquidations at fund maturity, thereby optimizing lifecycle flexibility.

In some embodiments, the ALP may allow liquidity suppliers invested in the pool to bid on specific ALP pool assets through an auction mechanism similar to the one described in U.S. Pat. No. 12,288,197, incorporated herein by reference.

In some embodiments, GPs may set up an ALP to add primary issuance fund interests or assets into the pool as well. This may allow for a much larger scale distribution at the primary issuance level as well.

In some embodiments, admins may earn additional fees on every dollar routed through the ALP by offering liquidity overlays to GPs' traditional funds.

In some embodiments, admins may retain control as the system of record while enabling daily/quarterly redemption overlays, fulfilling client demand for more competitive offerings.

In some embodiments, connecting the ALP to ecosystem rails (e.g., Calastone, DTCC) may allow fund admins to manage both primary and secondary transactions for client funds.

In some embodiments, ALPs may support smaller ticket sizes, shorter lockups, and automated compliance, making private funds more suitable for retail platforms and RIAs.

In some embodiments, the ALP may remove traditional operational barriers to fund distribution by addressing valuation and liquidity issues. The distribution may happen through insurance companies, bank deposits/balance sheets, corporate treasuries, evergreen funds, DeFi issuer, 401 k/DC plans, insurance products, private banks, fintechs, brokers/wirehouses/RIAs, DeFi capital holders.

In some embodiments, using smart contracts to automate liquidity and pricing may send a strong product innovation signal and reduces overhead for distribution partners.

In some embodiments, the ALP may have liquid, semi-liquid or illiquid assets.

In some embodiments, the ALP may act as a bridge for the DeFi community to gain exposure to institutional-grade credit/equity via stablecoin deployment without sacrificing liquidity or security.

In some embodiments, tokenization and deal segmentation may allow fractional ownership and algorithmic matching, eliminating the need for one-to-one trades and broadening participation.

In some embodiments, the Automated Liquidity pool idea may be used to set up multiple ALPs by different ALP managers for various assets and investor profiles. These ALPs may be interconnected to share liquidity among each other and may also allow investors wanting to sell their LP interests access to multiple ALPs, creating competitive pricing, which may be better for the overall ecosystem. Similarly, the ALP may also provide options to investors, again creating competition and improving the overall ecosystem health.

In some embodiments, the ALP may comprise at least two classes of participation interests, each with defined capital allocations and asset compositions. The first class may be exposed to only liquid assets and may receive a predetermined portion of return generated from the full portfolio of assets, as allocated by a manager in accordance with specified terms. The principal of the first class may remain protected by its liquid asset backing, such that losses in the second class's assets do not reduce the first class's principal but may reduce its return. The second class may be exposed to the full portfolio and may receive a portion of the return generated from the full portfolio of assets, as allocated by a manager in accordance with specified terms. and may allocate the remainder to the first class. The yield allocation ratio may be fixed or adjustable according to contractual or formula-based parameters and may further specify that a return allocated to the first class is capped at a predetermined return threshold, with any return above such threshold retained by the second class.

In some embodiments a credit risk profile of an asset or borrower may be the likelihood of the asset or borrower repaying the invested principal amount.

In some embodiments a network connected payment rail may be the underlying system infrastructure integrated within a network to allow moving capital among network participants.

In some embodiments a digital asset registry profile may be the authoritative bookkeeping instrument used for storing ownership rights in a financial asset. The digital asset registry may be a datastore on a server or on a blockchain.

In some embodiments a reference rate may refer to an externally published benchmark interest rate, determined by an independent authority or market administrator, that reflects short-term borrowing costs in the money market, and may include, without limitation, rates such as the Secured Overnight Financing Rate (SOFR), the London Interbank Offered Rate (LIBOR), the Mumbai Interbank Offered Rate (MIBOR), Treasury bill rates, or other equivalent market-accepted benchmarks.

In some embodiments, the ALP may support single-asset deposits on either side of the pool, such that asset holders (with LP interests) may deposit only their illiquid assets, and liquidity suppliers (with stablecoin or fiat holders) may deposit only liquid capital. This single-sided liquidity provisioning may more accurately reflect the real-world separation of capital and asset ownership in private markets. Stablecoin holders may not require custody LP interests, and conversely, LP sellers may not be required to hold stablecoins. The ALP's architecture may account for these operational and regulatory boundaries.

In some embodiments, since LPs in the ALP system may not hold paired positions and exit pricing may be governed by forward-looking models (not reserve ratios), the risk of impermanent loss may be eliminated. Yield distribution may be decoupled from token price volatility, making the ALP suitable for long-term capital allocators

It will be apparent to those skilled in the art that various modifications and variations can be made to Liquidity transaction 700 and/or embodiments of the present disclosure without departing from the spirit or scope of the present disclosure. Thus, it is intended that embodiments of the present disclosure cover the modifications and variations of this disclosure provided they come within the scope of the appended claims and their equivalents.

What is claimed is:

1. A computer-implemented method, executed on at least one server having a processor and a memory coupled over a network, for providing liquidity for financial assets, comprising:
receiving, using the processor or via a blockchain an asset owned by a user;
in response to accepting the asset, determining, using the processor executing a core algorithm, a projected liquidity ratio for one or more liquidity buckets stored in a database accessible to the at least one server;
splitting a discount into a first discount and a second discount, wherein the first discount is based on credit risk and valuation risk, wherein the second discount is based on liquidity risk;
applying, using the processor, the first discount based on a credit risk profile retrieved from a networked data store or the blockchain;
calculating, using the processor, a second discount based on the projected liquidity ratio and using a discount function stored in the memory;
allocating, using the processor, the asset to one or more liquidity buckets based on what type of liquidity transaction is used, and a set of bucket attributes associated with each liquidity bucket, wherein the liquidity buckets are maintained in the database stored on the at least one server;
transferring, using a network connected payment rail to the user providing liquid capital, a capital amount equal to a net asset value of the asset minus the first and second discounts and minus fees and expenses (payout=asset value−1^{st} discount−2^{nd} discount−fees−expenses); and
distributing, using an income-distribution model executed on the at least one server, a return from a pool of managed assets to the user, wherein the pool of managed assets are stored in a digital asset registry accessible by the system.

2. The method of claim 1, wherein the return from the pool of managed assets is split into a plurality of share classes and distributed to one or more users associated with each share class of the plurality of share classes.

3. The method of claim 1, wherein the second discount is determined using a dynamic discount curve selected from at least one of an exponential decay model or a multi-parameter bounded function.

4. The method of claim 1, further comprising:
reinvesting a portion of the return into one or more new liquidity buckets; and
updating at least one of the networked data store or the blockchain to reflect the reinvestment.

5. The method of claim 1, wherein the core algorithm is a modular algorithm and further includes:
an allocation sub-algorithm configured to determine an optimal allocation of assets into the one or more liquidity buckets;
an income-distribution sub-algorithm configured to distribute the return generated by the pool of managed assets; and
a pricing sub-algorithm configured to dynamically adjust at least one of a purchase discount or premium or a sale price for each asset based on real-time liquidity conditions within the pool of managed assets.

6. The method of claim 1, wherein the type of liquidity transaction used is at least one of: a direct purchase/sale, a repurchase agreement, or a hypothecation.

7. The method of claim 1, wherein the core algorithm is configured to automatically adjust the second discount amount to create incentives or disincentives with the objective of countering liquidity changes in the pool of managed assets.

8. The method of claim 1, wherein the set of bucket attributes includes at least one of: a lock-up period, a deposit size, a maturity date, or a current liquidity ratio.

9. The method of claim 4, wherein the return distribution among multiple share classes is executed using an algorithm configured to consider a relative size of the share classes and an additional return from the assets returning above a reference rate.

10. A computing system comprising:
a memory; and
a processor configured to receive, using the processor or via a blockchain an asset owned by a user, to determine, via a core algorithm, a projected liquidity ratio for one or more liquidity buckets stored in a database accessible to the at least one server, to split a discount into a first discount and a second discount, wherein the first discount is based on credit risk and valuation risk, wherein the second discount is based on liquidity risk, to apply, using the processor, the first discount based on a credit risk profile retrieved from a networked data store or the blockchain, to calculate a second discount based on the projected liquidity ratio and using a discount function stored in the memory, to allocate the asset to one or more liquidity buckets based on what type of liquidity transaction is used, and a set of bucket attributes associated with each liquidity bucket, wherein the liquidity buckets are maintained in a structured database stored on the at least one server, to transfer, using a network connected payment rail, to the user providing liquid capital, a capital amount equal to a net asset value of the asset minus the first and second discounts and minus fees and expenses (payout=asset value−1^{st} discount−2^{nd} discount−fees−expenses), and to distribute, using an income-distribution model executed on the at least one server, a return from a pool of managed assets to the user, wherein the pool of managed assets is stored in a digital asset registry accessible by the computing system.

11. The computing system of claim 10, wherein the return from the pool of managed assets is split into a plurality of share classes and distributed to one or more users associated with each share class of the plurality of share classes.

12. The computing system of claim 11, wherein the second discount is determined using a dynamic discount curve selected from at least one of an exponential decay model or a multi-parameter bounded function.

13. The computing system of claim 11, wherein the second discount is determined using a dynamic discount curve selected from at least one of an exponential decay model or a multi-parameter bounded function.

14. The computing system of claim 11, wherein the processor is further configured to reinvest a portion of the return into one or more new liquidity buckets, and to update at least one of the networked data store or the blockchain to reflect the reinvestment.

15. The computing system of claim 14, wherein the return distribution among multiple share classes is executed using an algorithm configured to consider a relative size of the share classes and an additional return from the assets returning above a reference rate.

16. A computer program product residing on a non-transitory computer-readable medium having a plurality of instructions stored thereon which, when executed by a processor, cause the processor to perform operations comprising:
receiving, using the processor or via a blockchain an asset owned by a user;
in response to accepting the asset, determining, using the processor executing a core algorithm, a projected liquidity ratio for one or more liquidity buckets stored in a database accessible to the at least one server;
splitting a discount into a first discount and a second discount, wherein the first discount is based on credit risk and valuation risk, wherein the second discount is based on liquidity risk;
applying, using the processor, the first discount based on a credit risk profile retrieved from a networked data store or the blockchain;
calculating, using the processor, a second discount based on the projected liquidity ratio and using a discount function stored in the memory;
allocating, using the processor, the asset to one or more liquidity buckets based on what type of liquidity transaction is used, and a set of bucket attributes associated with each liquidity bucket, wherein the liquidity buckets are maintained in the database stored on the at least one server;
transferring, using a network connected payment rail to the user providing liquid capital, a capital amount equal to a net asset value of the asset minus the first and second discounts and minus fees and expenses (payout=asset value−1^{st} discount−2^{nd} discount−fees−expenses); and
distributing, using an income-distribution model executed on the at least one server, a return from a pool of managed assets to the user, wherein the pool of managed assets are stored in a digital asset registry accessible by the system.

17. The computer program product of claim 16, wherein the return from the pool of managed assets is split into a plurality of share classes and distributed to one or more users associated with each share class of the plurality of share classes.

18. The computer program product of claim 17, wherein the second discount is determined using a dynamic discount curve selected from at least one of an exponential decay model or a multi-parameter bounded function.

19. The computer program product of claim 16, wherein the core algorithm is a modular algorithm and further includes:
an allocation sub-algorithm configured to determine an optimal allocation of assets into the one or more liquidity buckets;
an income-distribution sub-algorithm configured to distribute the return generated by the pool of managed assets; and
a pricing sub-algorithm configured to dynamically adjust at least one of a purchase discount or premium or a sale price for each asset based on real-time liquidity conditions within the pool of managed assets.

20. The computer program product of claim 16, wherein the operations further include:
reinvesting a portion of the return into one or more new liquidity buckets; and
updating at least one of the networked data store or the blockchain to reflect the reinvestment.

21. A computer-implemented method, executed on at least one server having a processor and a memory coupled over a network, comprising:
receiving, using the processor an asset;
determining a projected liquidity ratio for one or more liquidity buckets stored in a database accessible by the at least one server;
splitting a discount into a first discount and a second discount, wherein the first discount is based on credit risk and valuation risk, wherein the second discount is based on liquidity risk;
applying, using the processor, the first discount based on a credit risk profile retrieved from a networked data store or a blockchain;
calculating, using the processor, a second discount based on the projected liquidity ratio and using a discount function;
allocating, using the processor, the asset to one or more liquidity buckets based on what type of liquidity transaction is used, and a set of bucket attributes associated with each liquidity bucket;
transferring a capital amount equal to a net asset value of the asset minus the first and second discounts and minus fees and expenses; and
distributing, using an income-distribution model, a return from a pool of managed assets, wherein the pool of managed assets are stored in a digital asset registry.
